(19) United States
(12) Patent Application Publication
(10) Pub. No.: US 2022/0136079 A1
(43) Pub. Date: May 5, 2022

(54) METHOD OF EXTRACTING METAL IONS FROM BATTERIES

(71) Applicant: Nanyang Technological University, Singapore (SG)

(72) Inventors: Zhuoran WU, Singapore (SG); Chor Yong TAY, Singapore (SG); Madhavi SRINIVASAN, Singapore (SG)

(21) Appl. No.: 17/371,191

(22) Filed: Jul. 9, 2021

(30) Foreign Application Priority Data
Nov. 4, 2020 (SG) 10202010979T

(51) Int. Cl. C22B 3/16; H01M 10/54; H01M 4/04

(52) U.S. Cl. CPC C22B 3/165; H01M 2004/028; H01M 4/0497; H01M 10/54

(57) ABSTRACT

The present disclosure refers to a method of obtaining metal ions from a battery, the method comprising adding a crushed battery to a leaching solution comprising fruit and organic acid, thereby obtaining a leachate comprising metal ions, wherein the method is performed at a temperature above 80° C.

### TECHNICAL FIELD

The present disclosure generally refers to a method of obtaining metal ions from a battery. The present disclosure also generally refers to a method of recovering lithium cathode material from lithium-ion batteries.

### BACKGROUND ART

Lithium-ion batteries (LIBs), due to their high energy density, long lifespan, low self-discharge rate and high electric currents, are currently used in a wide range of electronic products (e.g. smartphones, notebooks, cameras, electronic vehicles, medical devices, etc.) and have become an indispensable part of our daily life. The global market value of LIBs is expected to reach a staggering $139 billion by 2026. As the demand for LIBs continues to grow at a rapid pace in the global world today, so does the pile of spent electronic battery waste such as LIBs waste.

Current approaches to handle spent LIBs waste are not only unsustainable, they are also regarded as a serious risk to the environment. Large amounts of valuable metals (e.g. Li, Co, Ni, Mn, etc.) are lost during the incineration process. Heavy metals from the LIBs waste, once dumped to the landfill, may enter the living environment through dissolution into water, potentially causing pollution to the drinking water and even a health hazard to human beings. Hence, many developed countries have already initiated and implemented recycling technologies with an aim to replace the traditional methodology for handling LIBs waste.

However, despite these efforts, only 2% and 5% of the LIBs waste are currently recycled per annum in Australia and European Union (EU), respectively. With a typical lifespan of approximately two to three years, the majority of spent LIBs are still subjected to conventional pyrolysis treatment and often end up in landfills or incinerators, which are both environmentally unfriendly and economically unwise. LIBs waste contains numerous valuable resources like cobalt (Co), lithium (Li) and other metals such as nickel (Ni), manganese (Mn) that could be recycled, recovered and reused. In fact, out of the $23.51 billion worth of the LIBs that are annually produced, most of the value stems from these metallic constituents.

Current methods to recycle LIBs include pyrometallurgy, bio-metallurgy and hydrometallurgy. Pyrometallurgy refers to the thermal treatment of the LIBs waste at extremely high temperature (>500° C.) to smelt the valuable metals. Although this process is widely used in the industry, it is characteristically energy-intensive and emits a substantial level of hazardous toxic gas. Comparatively, the use of acid-generating microbes (bacteria/fungi) such as Acidithiobacillus ferrooxidans, Acidithiobacillus thiooxidans, Aspergillus niger to extract heavy metals from the LIBs waste in bio-metallurgy exert minimal environmental and health impacts. However, the industrial adoption of this process is severely curtailed due to the inefficiency of the bio-leaching process (i.e. a typical long processing time of up to few months, which is partially due to either the slow production rate of reducing metabolites or the toxicity that results from the concentrated heavy metal solution), and the susceptibility of the microbes to the toxic effects of the metals. In contrast, hydrometallurgy, which makes use of water as a solvent, provides a more direct metal recovery route. In terms of the operational conditions, the processing temperatures in hydrometallurgy (10° C. to 200° C.) are significantly lower than those in pyrometallurgy and its efficiency is independent of the growth kinetics of the microbes in bio-metallurgy. Additionally, the low energy consumption, high recovery rate and ease of operation associated with hydrometallurgy make it a highly attractive approach to treat LIBs waste.

Conventional hydrometallurgical processes rely heavily on the combinatorial use of strong inorganic acids (e.g. H₂SO₄, HCl, HNO₃) and reductants (e.g. H₂O₂) to leach out metals from spent cathode materials. However, the industrial-scale utilization of strong acids will generate substantial amounts of secondary pollutants such as SO₃, Cl₂ and NON, which may pose significant potential safety, environmental and health risks. Furthermore, the use of strong acid is typically undesirable for leaching equipment, machinery, as well as the environment. Therefore, several studies have started to explore the use of less hazardous and weak organic acids such as formic, salicylic, citric, gluconic, itaconic, succinic, and acetic acids to replace the strong acids. When combined with hydrogen peroxide (H₂O₂) as the reducing agent, these mild organic acids can be as effective as mineral acids and also environmentally-safe. For instance, leaching efficiencies of Li and Co from discarded LiCoO₂ (LCO) in citric acid (H₃Cit, 1.25 M) was reported to increase from 54% to 99% and 25% to 91% respectively when H₂O₂ (1.0 vol %) was added to the lixiviant. At an optimized combination of tartaric acid (0.6 mol/L) and H₂O₂ (3 vol %), selective leaching of Li (99.1%) can be achieved from cathode materials of spent LIBs. Additionally, tartaric acid can also concomitantly function as a precipitation agent for the recovery of cobalt tartrate with purity of 96.4%. While the effectiveness of H₂O₂ as a reducing agent is undisputed, long-term reliance on it is hardly sustainable since H₂O₂ is highly explosive, hazardous and unstable. Thus, the search for greener alternatives to H₂O₂ has gained significant traction in recent years. Experiments using alternative inorganic reductants such as sodium thiosulfate and sodium bisulfite (NaHSO₃) have shown that conditions can be optimized to achieve 80-90% leaching efficiencies of Li and Co from spent LIBs cathode materials. Nonetheless, the introduction of sodium ion (Na⁺) to the lixiviant may contaminate the final recovered products as well as incur additional operational cost for downstream product purification steps.

There is therefore a need to search for greener alternative extraction agents. There is also a need to develop a greener hydrometallurgy method that can overcome, or at least ameliorate, one or more of the disadvantages described above.

### SUMMARY OF INVENTION

In one aspect, the present disclosure refers to a method of obtaining metal ions from a battery, the method comprising adding a crushed battery to a leaching solution comprising fruit and organic acid, thereby obtaining a leachate comprising metal ions, wherein the method is performed at a temperature above 80° C.

In another aspect, the present disclosure refers to a method of obtaining metal salt from a battery, the method comprising:
(i) adding a crushed battery to a leaching solution comprising fruit and organic acid, thereby obtaining a leachate comprising metal ions; and
(ii) adding a first precipitating agent to the leachate of step (i), thereby obtaining a first precipitate comprising metal salt and filtrate,
   wherein step (i) is performed at a temperature above 80° C.

In yet another aspect, the present disclosure refers to a method of recovering and regenerating lithium cathode material from lithium-ion battery (LIB), the method comprising:
(i) adding a crushed LIB to a leaching solution comprising fruit and organic acid, thereby obtaining a leachate comprising metal ions;
(ii) adding a first precipitating agent to the leachate of step (i), thereby obtaining a first precipitate comprising metal salt and filtrate;
(iii) adding a second precipitating agent to the filtrate of step (ii) to obtain a second precipitate; and
(iv) mixing the second precipitate of step (iii) with a lithium salt and heating the resulting mixture to obtain a lithium cathode material;
wherein step (i) is performed at a temperature above 80° C.

Advantageously, using fruit waste for recycling of end-of-life battery waste (such as LIBs) is an environmentally-friendly, green, sustainable and cost-effective approach which uses waste to treat waste and at the same time recycle, recover and regenerate valuable resources for future use. The purposeful exploitation of fruit-based waste products for the treatment of battery waste can also be termed “waste-for-waste” approach. The present disclosure is a realistic strategy of recycling fruit waste and battery waste (which would otherwise be dumped to landfill), saving cost on materials and resources and is in alignment with the concept of circular economy. The methods of the present disclosure also co-tackle the twin global challenges of resource depletion (e.g. metals) and waste accumulation (electronic and batteries waste and food waste).

Also advantageously, the use of fruit waste as a green reductant for the acid leaching of valuable metals from batteries is a safer alternative than conventional hydrometallurgical processes which use strong inorganic acids and reductants. With the combinatorial use of fruit waste as a green reductant and less hazardous and weak organic acids in the present disclosure, the materials used are safe, biodegradable, not highly explosive, not hazardous and relatively stable (unlike hydrogen peroxide, H₂O₂). Further, the disclosed method does not generate substantial amounts of secondary pollutants such as SO₃, Cl₂ and NOₓ, and may not pose significant potential safety, environmental and health risks.

Further advantageously, by replacing hydrogen peroxide with fruit waste and strong inorganic acids with weak organic acid, the methods of the present disclosure not only efficiently reduce the risk of secondary pollution but also obtain as good a performance as (as efficient as) that by using the combination of strong acids and hydrogen peroxide. Further, the temperature used in the disclosed method is considered to be lower and less energy intensive (lower energy consumption) than the typical processing temperatures used in hydrometallurgy, which can go to a temperature of 200° C.

In summary, the present disclosure facilitates recycling of battery waste such as LIBs waste with good efficiency, cost effectiveness and minimal pollution and health hazard to both the living environment and workers who work at battery (e.g. LIBs) waste recycling plants.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

The term “black mass” refers to shredded and/or crushed components of a battery (such as metal-ion batteries) containing cathode, anode, plastic binder, battery shell and/or other components of a battery.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate disclosed embodiments and serve to explain the principles of the disclosed embodiments. It is to be understood, however, that the drawings are designed for purposes of illustration only, and not as a definition of the limits of the invention.

FIGS. 1A and 1B

FIG. 1A is a diagram showing the use of orange peel (OP) in recycling of spent lithium-ion batteries.

FIG. 1B is a diagram depicting how fruit peel waste (e.g. orange peel waste) extracts metals from spent lithium-ion batteries (LIBs).

FIG. 2A-B

FIG. 2 is a series of SEM images showing: (A) pure LiCoO₂ (LCO) and (B) lithium-ion batteries (LIBs) black mass, scale bar=1 μm.

FIG. 3 FIG. 3 is a diagram illustrating the processing of orange peel into particles/powder.

FIG. 4A-B

FIG. 4 is a series of graphs showing the time-course measurement of (A) reducing sugars and (B) antioxidant capacity of orange peel (OP) in H₃Cit (1 M) where the reaction conditions are as follows: Amount of OP: 200 g; and temperature: 90° C.

FIG. 5 is a series of graphs showing the time-dependent leaching efficiency of Co and Li in LCO solution (LiCoO₂) using either H₃Cit (∘) or H₃Cit+OP (⋄) containing lixiviant at different temperatures (60° C., 75° C., 90° C.) where the leaching conditions are as follows: 40 ml of H₃Cit (1 M), OP=200 mg; LCO=500 mg. Data are presented as mean±standard deviation.

FIG. 6 is a series of graphs showing a comparison of the leaching efficiency of cobalt (Co) and lithium (Li) in LiCoO₂ (LCO) solution between using orange peel (OP) and d-glucose with the same mass.

FIG. 7 is a series of graphs showing the leaching efficiency of various metals Ni, Mn, Co, Li and Al in lithium-ion batteries (LIBs) black mass-containing lixiviant using either H₃Cit or H₃Cit+OP. Leaching conditions are as follows: H₃Cit (1 M), lixiviant volume=40 ml, OP=200 mg, LCO=500 mg, black mass=200 mg, leaching temperature=90° C., and leaching duration=7 h. Data are presented as mean±standard deviation. * denotes significant difference between the indicated experimental groups. p<0.05.

FIG. 8 is a graph showing the leaching efficiency of various metals in black mass with different types of fruit skins in citric acid (H₃Cit, 1M).

FIG. 9 is a graph showing the leaching efficiency of various metals in black mass with actual food waste (w/w=1) in citric acid (H₃Cit, 1M).

FIG. 10A-D

FIG. 10 is a series of graphs showing the effect of reductant amount on the leaching efficiency of (A) Co, (B) Li, (C) Ni and (D) Mn in lithium-ion batteries (LIBs) black mass-containing lixiviant using either OP (0) or H₂O₂ (A) as the reductant. Leaching conditions are as follows: H₃Cit (1 M), lixiviant volume=40 ml, black mass=200 mg, leaching temperature=90° C., and leaching duration=4 h. Data are presented as mean±standard deviation.

FIG. 11A-D

FIG. 11 is a series of graphs showing the effect of temperature on the leaching efficiency of (A) Co, (B) Li, (C) Ni and (D) Mn in lithium-ion batteries (LIBs) black mass-containing lixiviant using either OP (0) or H₂O₂ (A) as the reductant. Leaching conditions are as follows: H₃Cit (1 M), lixiviant volume=40 ml, OP=200 mg, H₂O₂=400 mg, black mass=200 mg, and leaching duration=4 h. Data are presented as mean±standard deviation.

FIG. 12A-D

FIG. 12 is a series of graphs showing the effect of H₃Cit concentration on the leaching efficiency of (A) Co, (B) Li, (C) Ni and (D) Mn LIBs black mass-containing lixiviant using either OP (∘) or H₂O₂ (Δ) as the reductant. Leaching conditions are as follows: Lixiviant volume=40 ml, OP=200 mg, H₂O₂=400 mg, black mass=200 mg, leaching temperature=100° C. and leaching duration=4 h. Data are presented as mean±standard deviation.

FIG. 13A-D

FIG. 13 is a series of graphs showing the effect of slurry density (w_{black mass}/v_{leaching solution}) on the leaching efficiency of (A) Co, (B) Li, (C) Ni and (D) Mn LIBs black mass-containing lixiviant using either OP (∘) or H₂O₂ (Δ) as the reductant. Leaching conditions are as follows: H₃Cit (1.5 M), lixiviant volume=40 ml, OP=200 mg, H₂O₂=400 mg, leaching temperature=100° C. and leaching duration=4 h. Data are presented as mean±standard deviation.

FIG. 14A-B

FIG. 14 is a series of graphs showing (A) X-ray fluorescence spectrum of the solid residues by-product where relative (%) abundance of the detected elements are indicated in the parenthesis; and (B) cell viability of HaCaT, HDF and NCM460 exposed to the solid residues at concentrations ranging from 0 to 1000 μg/ml. Data are presented as mean±SD derived from three independent experiments.

FIG. 15 shows the X-ray fluorescence spectrum of the recovered cobalt hydroxide and relative (wt. %) abundance of the detected elements.

FIG. 16 is a graph showing the recovery efficiency (%) of cobalt (Co) from 4 different batches of orange peel (OP) leaching solution.

FIG. 17A-C

FIG. 17 is a series of graphs showing the (A) XRD pattern of commercial (top) and regenerated (bottom) LCO; (B) initial charge (dotted)—discharge (solid) performance of the regenerated LCO coin cell; and (C) the stability of discharge capacity over 10 cycles of charge and discharge.

### DETAILED DISCLOSURE OF SELECTED DRAWINGS

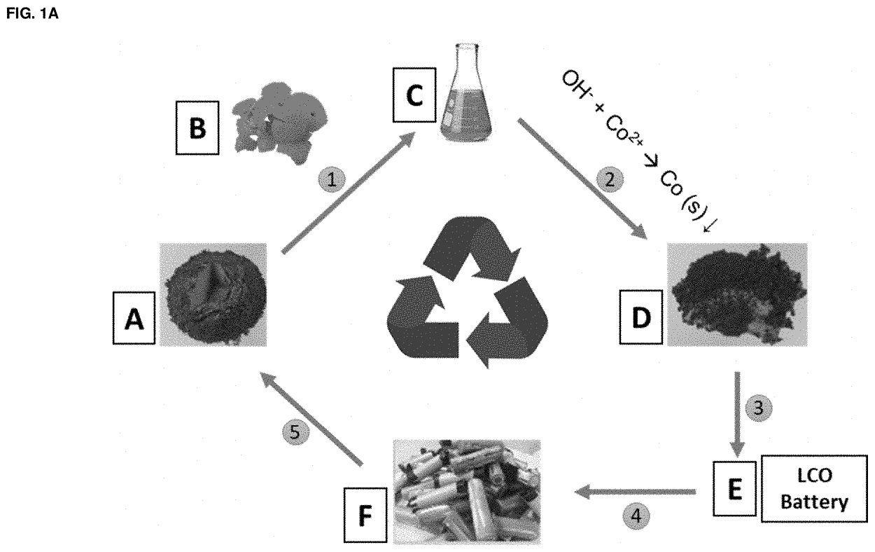

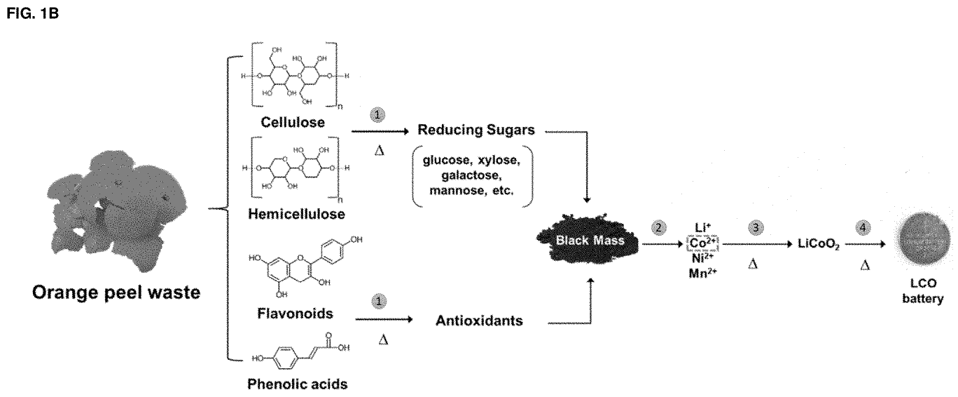

Referring to FIG. 1A, it is shown how orange peel waste (B) may be used as a reductant for the leaching of battery scraps. Black mass (A) is added to orange peel (B) which results in the in-situ leaching of metal ions (1), thereby producing a solution containing Co′ (C). The Co²⁺ solution undergoes controlled precipitation (2) to produce Co(OH)₂ (D) which is subsequently utilized in battery assembly (3) to fabricate new LiCoO₂ (LCO) batteries (E). After the newly fabricated LCO batteries (E) are used and spent (4), they become LIBs waste (F). The LIBs waste (F) is then processed by discharging, shredding, or grinding then sieving (5) to form black mass (A), which then undergoes the same recycling process to form new LCO batteries.

Referring to FIG. 1B, fruit peel waste, such as orange peel waste, is comprised of a large quantity of crude fiber-rich substances (e.g. cellulose and hemicellulose) as well as antioxidants such as flavonoids and phenolic acids, all of which are potentially active reagents that are conducive to metal extraction process via typical redox reaction. These crude fibers and antioxidants can be heated (A) (1) and subsequently decomposed under certain conditions, for instance, when subject to mild heat in acids. These crude fibers and antioxidants can be converted to a number of reducing sugars such as d-glucose, xylose, galactose, mannose, etc. All these sugars that possess reducing capacity can interact with the LIBs waste (e.g. black mass) and thereafter facilitate the metals (e.g. lithium, cobalt, nickel and manganese) being extracted and leached out (2) from the waste. Eventually, the leached-out metals (especially Co) would be heated, reduced and eventually precipitated and reconstituted (3) to form LiCoO₂. LiCoO₂ can be further heated and regenerated (4) and utilized to form new LCO batteries.

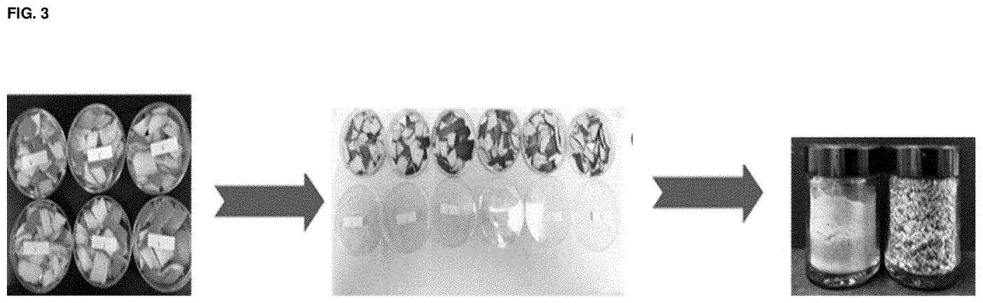

Referring to FIG. 3, orange peel waste may be first prepared by oven drying (1) and subsequently undergoing a series of processes of cutting, blending, grinding and sieving (2) to produce an orange peel powder of a desirable size.

### DETAILED DISCLOSURE OF EMBODIMENTS

The development of environmentally-benign hydrometallurgical processes to treat spent batteries such as lithium ion batteries (LIBs) is a critical aspect of the electronic-waste circular economy. Herein, as an alternative to highly explosive hydrogen peroxide (H₂O₂), fruit peel waste, such as discarded orange peel powder (OP), is valorized as a green reductant for the leaching of industrially produced LIBs scraps in an acid (e.g. citric acid, H₃Cit) lixiviant.

The present disclosure refers to a method of obtaining metal ions from a battery, the method comprising adding a crushed battery to a leaching solution comprising fruit and organic acid, thereby obtaining a leachate comprising metal ions, wherein the method is performed at a temperature above about 80° C.

The battery may be any metal ion battery, such as aluminium-ion batteries, lithium-ion batteries, potassium-ion batteries, magnesium-ion batteries, zinc-ion batteries and sodium-ion batteries.

The method may be performed at any temperature above about 80° C., such as about 81° C., about 82° C., about 83° C., about 84° C., about 85° C., about 86° C., about 87° C., about 88° C., about 89° C., about 90° C., about 91° C., about 92° C., about 93° C., about 94° C., about 95° C., about 96° C., about 97° C., about 98° C., about 99° C., about 100° C., about 101° C., about 102° C., about 103° C., about 104° C., about 105° C., about 106° C., about 107° C., about 108° C., about 109° C., about 110° C., about 111° C., about 112° C., about 113° C., about 114° C., about 115° C., about 116° C., about 117° C., about 118° C., about 119° C., about 120° C. and upwards.

The method may be performed at a temperature in the range of about 90° C. to about 120° C., about 90° C. to about 115° C., about 90° C. to about 110° C., about 90° C. to about 105° C., about 90° C. to about 100° C., about 90° C. to about 95° C., about 95° C. to about 120° C., about 100° C. to about 120° C., about 105° C. to about 120° C., about 110° C. to about 120° C., about 115° C. to about 120° C., about 90° C., about 91° C., about 92° C., about 93° C., about 94° C., about 95° C., about 96° C., about 97° C., about 98° C., about 99° C., about 100° C., about 101° C., about 102° C., about 103° C., about 104° C., about 105° C., about 106° C., about 107° C., about 108° C., about 109° C., about 110° C., about 111° C., about 112° C., about 113° C., about 114° C., about 115° C., about 116° C., about 117° C., about 118° C., about 119° C., about 120° C., or any value or range therein.

The crushed battery may be obtained by shredding, pulverizing, grinding, cutting, and/or blending a battery. The battery may be fully discharged prior to shredding, pulverizing, grinding, cutting and/or blending. The battery may be shredded, pulverized, grinded, cut and/or blended without prior dismantling. The crushed battery may be obtained using any instrument and machinery that can break, cut, shred, grind, pulverize and/or blend a battery, such as a shaft shredder, pre-chopper, mechanism cutter, or battery cutter. The crushed battery may be sieved to remove any plastic constituents. The resulting sieved crushed battery may be in particulate form. The particulate may be a black mass particulate.

The fruit may be selected from the group consisting of orange, pear, lemon, apple, banana, lime, pineapple, grapefruit, blackberry, raspberry, cranberry, tamarind, grape, mango, papaya, honeydew, pomelo, watermelon, kiwi, plum, peach, lime, sweet potato, avocado, cucumber, dragon fruit, guava, jackfruit, durian and mixtures thereof.

By the term “fruit”, it is intended to refer to the whole of the fruit, including its peel, flesh and seeds.

The fruit used in the disclosed methods may be primarily fruit peel. The fruit peel may be peel that has been discarded after the flesh of the fruit has been consumed, and therefore be considered “waste”.

The fruit may be in powder form. The fruit may be dried substantially or completely using sun, heat, high temperature, a dryer, an oven, a freeze dryer or a dehydrator. The dried fruit may be subsequently cut, chopped, shredded, grinded and/or blended to obtain a fruit powder. Alternatively, prior to drying, the fruit may be first cut, torn, sliced, chopped and/or shredded into small pieces before drying, freeze drying, heating (using the sun, high temperature, dryer and/or oven), and/or dehydrating. The dried fruit may be further grated, grinded and blended to obtain a fruit powder.

The average particle size of the fruit powder may be in the range of about 100 μm to about 500 μm, about 100 μm to about 450 μm, about 100 μm to about 400 μm, about 100 μm to about 350 μm, about 100 μm to about 300 μm, about 100 μm to about 250 μm, about 100 μm to about 200 μm, about 100 μm to about 150 μm, about 150 μm to about 500 μm, about 200 μm to about 500 μm, about 250 μm to about 500 μm, about 300 μm to about 500 μm, about 350 μm to about 500 μm, about 400 μm to about 500 μm, about 450 μm to about 500 μm, about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, about 300 μm, about 310 μm, about 320 μm, about 330 μm, about 340 μm, about 350 μm, about 360 μm, about 370 μm, about 380 μm, about 390 μm, about 400 μm, about 410 μm, about 420 μm, about 430 μm, about 440 μm, about 450 μm, about 460 μm, about 470 μm, about 480 μm, about 490 μm, about 500 μm, or any value or range therein.

The organic acid may be selected from the group consisting of citric acid, acetic acid, tartaric acid, maleic acid, oxalic acid, L-ascorbic acid, succinic acid, quinic acid, isocitric acid, tannic acid, caffeic acid, lactic acid, formic acid, uric acid, barbituric acid, benzenesulfonic acid, benzoic acid, bromoacetic acid, chloroacetic acid, fumaric acid, gallic acid, methane sulfonic acid, phthalic acid, propionic acid, salicylic acid, sorbic acid, p-toluene sulfonic acid, fluoroantimonic acid, erucic acid, lauric acid, butyric acid, and mixtures thereof.

The concentration of organic acid can be in the range of about 1.0 M to about 5.0 M, of about 1.0 M to about 4.5 M, of about 1.0 M to about 4.0 M, of about 1.0 M to about 3.5 M, of about 1.0 M to about 3.0 M, of about 1.0 M to about 2.5 M, of about 1.0 M to about 2.0 M, of about 1.0 M to about 1.5 M, of about 1.5 M to about 5.0 M, of about 2.0 M to about 5.0 M, of about 2.5 M to about 5.0 M, of about 3.0 M to about 5.0 M, of about 3.5 M to about 5.0 M, of about 4.0 M to about 5.0 M, of about 4.5 M to about 5.0 M, of about 1.0 M, of about 1.1 M, of about 1.2 M, of about 1.3 M, of about 1.4 M, of about 1.5 M, of about 1.6 M, of about 1.7 M, of about 1.8 M, of about 1.9 M, of about 2.0 M, of about 2.1 M, of about 2.2 M, of about 2.3 M, of about 2.4 M, of about 2.5 M, of about 2.6 M, of about 2.7 M, of about 2.8 M, of about 2.9 M, of about 3.0 M, of about 3.1 M, of about 3.2 M, of about 3.3 M, of about 3.4 M, of about 3.5 M, of about 3.6 M, of about 3.7 M, of about 3.8 M, of about 3.9 M, of about 4.0 M, of about 4.1 M, of about 4.2 M, of about 4.3 M, of about 4.4 M, of about 4.5 M, of about 4.6 M, of about 4.7 M, of about 4.8 M, of about 4.9 M, of about 5.0 M, or any value or range therein.

The metal ions obtained by the methods disclosed herein may comprise nickel, manganese, cobalt, lithium, iron, vanadium, silicon, titanium, tin, chromium, copper and/or aluminum ions.

The density of the crushed battery in the leaching solution (w_{crushed battery}/v_{leaching solution}) may be about 5 g/L to about 50 g/L, about 5 g/L to about 45 g/L, about 5 g/L to about 40 g/L, about 5 g/L to about 35 g/L, about 5 g/L to about 30 g/L, about 5 g/L to about 25 g/L, about 5 g/L to about 20 g/L, about 5 g/L to about 15 g/L, about 5 g/L to about 10 g/L, about 10 g/L to about 50 g/L, about 15 g/L to about 50 g/L, about 20 g/L to about 50 g/L, about 25 g/L to about 50 g/L, about 30 g/L to about 50 g/L, about 35 g/L to about 50 g/L, about 40 g/L to about 50 g/L, about 45 g/L to about 50 g/L, about 5 g/L, about 6 g/L, about 7 g/L, about 8 g/L, about 9 g/L, about 10 g/L, about 11 g/L, about 12 g/L, about 13 g/L, about 14 g/L, about 15 g/L, about 16 g/L, about 17 g/L, about 18 g/L, about 19 g/L, about 20 g/L, about 21 g/L, about 22 g/L, about 23 g/L, about 24 g/L, about 25 g/L, about 26 g/L, about 27 g/L, about 28 g/L, about 29 g/L, about 30 g/L, about 31 g/L, about 32 g/L, about 33 g/L, about 34 g/L, about 35 g/L, about 36 g/L, about 37 g/L, about 38 g/L, about 39 g/L, about 40 g/L, about 41 g/L, about 42 g/L, about 43 g/L, about 44 g/L, about 45 g/L, about 46 g/L, about 47 g/L, about 48 g/L, about 49 g/L, about 50 g/L, or any value or range therein.

The method may further comprise a step of adding a first precipitating agent to the leachate, thereby obtaining a first precipitate comprising metal salt and filtrate.

Hence, the present disclosure also refers to a method of obtaining metal salt from a battery, the method comprising:
(i) adding a crushed battery to a leaching solution comprising fruit and organic acid, thereby obtaining a leachate comprising metal ions; and
(ii) adding a first precipitating agent to the leachate of step (i), thereby obtaining a first precipitate comprising metal salt and filtrate,
   wherein step (i) is performed at a temperature above 80° C.

The method may also further comprise step (iii) adding a second precipitating agent to the filtrate of step (ii) to obtain a second precipitate.

Hence, the present disclosure also refers to a method of obtaining metal salt from a battery, the method comprising:
(i) adding a crushed battery to a leaching solution comprising fruit and organic acid, thereby obtaining a leachate comprising metal ions;
(ii) adding a first precipitating agent to the leachate of step (i), thereby obtaining a first precipitate comprising metal salt and filtrate; and
(iii) adding a second precipitating agent to the filtrate of step (ii) to obtain a second precipitate,
   wherein step (i) is performed at a temperature above 80° C.

The metal salt may be a nickel salt, manganese salt, cobalt salt, lithium salt, iron salt, vanadium salt, silicon salt, titanium salt, tin salt, chromium salt, copper salt and/or aluminum salt.

The first precipitating agent of step (ii) may be selected from the group consisting of sodium hydroxide (NaOH), sodium chloride (NaCl), sodium bisulfate (NaHSO₄), monosodium phosphate (NaH₂PO₄), sodium carbonate (Na₂CO₃), sodium bicarbonate (NaHCO₃), trisodium phosphate (Na₃PO₄), sodium sulfite (Na₂SO₃), disodium phosphate (Na₂HPO₄), calcium hydroxide (Ca(OH)₂), magnesium hydroxide (Mg(OH)₂), and any mixture thereof. The first precipitating agent may be added in an amount to adjust the pH of the leachate in the range of about 10 to about 14, or about 10 to about 13.5, about 10 to about 13, about 10 to about 12.5, about 10 to about 12, about 10 to about 11.5, about 10 to about 11, about 10 to about 10.5, about 10.5 to about 14, about 11 to about 14, about 11.5 to about 14, about 12 to about 14, about 12.5 to about 14, about 13 to about 14, about 13.5 to about 14, or about 10, about 10.5, about 11, about 11.5, about 12, about 12.5, about 13, about 13.5, about 14, or any value or range therein.

The first precipitate may comprise manganese salt and/or nickel salt.

The second precipitating agent may comprise an alcohol. The alcohol may be methanol, ethanol, propanol, iso-propanol, butanol, sec-Butyl alcohol, isobutyl alcohol, tert-Butyl alcohol, or isomers and/or mixtures thereof.

The ratio of the volume of the second precipitating agent to the volume of the filtrate of step (ii) may be in the range of about 1:20 to about 1:5, about 1:19 to about 1:5, about 1:18 to about 1:5, about 1:17 to about 1:5, about 1:16 to about 1:5, about 1:15 to about 1:5, about 1:14 to about 1:5, about 1:13 to about 1:5, about 1:12 to about 1:5, about 1:11 to about 1:5, about 1:10 to about 1:5, about 1:9 to about 1:5, about 1:8 to about 1:5, about 1:7 to about 1:5, about 1:6 to about 1:5, about 1:20 to about 1:6, about 1:20 to about 1:7, about 1:20 to about 1:8, about 1:20 to about 1:9, about 1:20 to about 1:10, about 1:20 to about 1:11, about 1:20 to about 1:12, about 1:20 to about 1:13, about 1:20 to about 1:14, about 1:20 to about 1:15, about 1:20 to about 1:16, about 1:20 to about 1:17, about 1:20 to about 1:18, about 1:20 to about 1:19, or about 1:5, or about 1:6, or about 1:7, or about 1:8, or about 1:9, or about 1:10, or about 1:11, or about 1:12, or about 1:13, or about 1:14, or about 1:15, or about 1:16, or about 1:17, or about 1:18, or about 1:19, or about 1:20, or any value or range therein.

The second precipitate may comprise a cobalt salt.

The method of the present disclosure may also be used to recover and regenerate lithium cathode material from a lithium-ion battery.

Hence, the present disclosure also refers to a method of recovering and regenerating lithium cathode material from lithium-ion battery (LIB), the method comprising:
(i) adding a crushed LIB to a leaching solution comprising fruit and organic acid, thereby obtaining a leachate comprising metal ions;
(ii) adding a first precipitating agent to the leachate of step (i), thereby obtaining a first precipitate comprising metal salt and filtrate;
(iii) adding a second precipitating agent to the filtrate of step (ii) to obtain a second precipitate; and
(iv) mixing the second precipitate of step (iii) with a lithium salt and heating the resulting mixture to obtain a lithium cathode material;

wherein step (i) is performed at a temperature above 80° C.

The lithium salt may be selected from the group consisting of lithium hydroxide, lithium carbonate, lithium nitrate, lithium acetate, lithium oxalate, lithium chloride, lithium phosphate, lithium sulfate, lithium borate, lithium oxide, and any mixture thereof.

The lithium cathode material may be selected from the group consisting of lithium cobalt oxide (LCO), lithium manganese oxide (LMO), lithium nickel manganese cobalt oxide (LNMCO), lithium titanium oxide (LTO), lithium iron phosphate (LFP), lithium oxido(oxo)nickel (LiNiO₂), lithium manganese dioxide (LiMnO₂), LiNi_{0.5}Mn_{1.5}O₄ (Spinel, LNMO), lithium manganese phosphate (LiMnPO₄), lithium nickel phosphate (LiNiPO₄), lithium cobalt phosphate (LiCoPO₄), and any mixture thereof.

### EXAMPLES

Non-limiting examples of the invention and comparative examples will be further described in greater detail by reference to specific examples, which should not be construed as in any way limiting the scope of the invention.

Citric acid monohydrate, hydrochloric acid fuming 37%, sodium hydroxide pellets, 3,5-dinitrosalicylic acid, anhydrous glucose, and Soxhlet extraction apparatus were purchased from Sigma-Aldrich. Concentrated nitric acid (69%) and WHAT extraction thimble (43×123 mm) were purchased from VWR™. Concentrated sulfuric acid (95-97%) and hydrogen peroxide (30% in H₂O) was purchased from Honeywell. 2,2′-Azino-bis(3-ethylbenzothiazoline-6-sulfonic acid) diammonium salt (ABTS) assay kit was purchased from Beyotime, China. Dulbecco's Modified Eagle's Medium (DMEM-High glucose), Fetal Bovine Serum (FBS, heat inactivated), and Antibiotic-Antimycotic were purchased from GE Hyclone. Resazurin sodium salt (alarmarBlue) was purchased from Sigma-Aldrich. All chemicals purchased and employed in this study were of analytical grade and solutions were prepared using Milli-Q® ultrapure water.

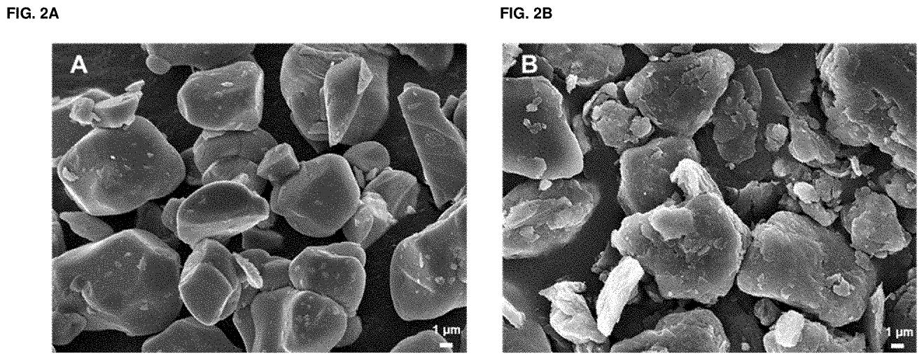

The waste cathode material LiCoO₂ (LCO) and spent LIBs were kindly supplied by Nanyang Technological University, School of Mechanical and Aerospace Engineering and School of Material Science and Engineering. Scanning electron microscopy (SEM) images of the LCO and spent LIBs are shown in FIG. 2. The metallic composition of black mass was analyzed using inductively coupled plasma atomic emission spectroscopy (ICP-OES).

### Example 1: Pre-Processing of Spent Lithium-Ion Batteries (LIBs)

Spent LCO cylindrical cells have a voltage that ranges from 3.1V to 3.4V. To prevent flame and explosion hazards, the LCO batteries were fully discharged by submerging them in 20 weight % sodium chloride (NaCl) solution overnight. The complete discharge of the batteries was confirmed using a battery tester (BT3554). Next, the fully discharged LCO batteries were shredded without prior dismantling using a custom-made shredder designed for battery processing (up to 10 kg/h) under inert gas condition at room temperature. The shredded materials (containing not just cathode but a combination of anodes, plastic binder, battery shells and other substances) were then kept under exhaust suction overnight prior to being air-dried in a fume cupboard. Finally, the shredded materials were grinded using a commercial food processor (JDC 3 L, 300 W) for approximately 1 minute and sieved using a 60 μm mesh to remove the plastic constituents. The resultant fine particulate is termed “black mass” and was stored in a desiccator for subsequent experimentations.

### Example 2: Preparation and Characterization of Orange Peel (OP)

Orange peel (OP) was obtained from fresh oranges bought from a local supermarket. The OP was immediately separated from the flesh and cut into pieces (˜2 to 3 cm in length and ˜2 to 4 mm in thickness). The OP samples were then extracted and oven-dried for 3 days at a constant temperature of 60° C. to ensure complete removal of moisture and water content. The dried OP was then pulverized and sieved with a #60 mesh (pore size=250 μm). The preparation process of OP (which includes air-drying, cutting, blending, grinding and sieving) in order to attain an orange peel powder with a desirable size (of <250 μm) is summarized and illustrated in FIG. 3. Those dry OP particles which were unable to pass through the sieve were also kept in stock for further investigation of the size effect of OP on the metal extraction process.

The composition, elemental analysis, lignocellulosic constituent of OP employed in this study were characterized via established methodologies and the results are tabulated in Table 1 below. Moisture content of OP was determined by comparing the weight difference before and after the oven drying process. Volatile content was obtained via thermogravimetric analysis (TGA) at a temperature increment rate of 50° C. per min and stabilized at 900° C. under N₂ environment for 7 min. Ash content was acquired through TGA analysis at a temperature increment rate of 3° C. per min until it reached 700° C. under 02 environment. The fixed carbon content was calculated using the following expression:

Fixed carbon %=100%−Moisture %−Volatile %−Ash % Equation (1)

The absolute elemental content was determined using the CHNS (carbon, hydrogen, nitrogen and sulfur) elemental analyzer. The oxygen content was calculated using the following expression:

Oxygen %=100%−C %−H %−N %−S %−Ash % Equation (2)

The lignocellulosic composition of OP was quantified using an established protocol and the cellulose content was calculated using the following expression:

Cellulose %=100%−Extractive %−Hemicellulose %−Lignin %−Ash % Equation (3)

TABLE 1
Compositional analysis of orange peel (OP)

| Analysis | Orange Peel | Percent (%) | Technique |
|---|---|---|---|
| Proximate | Moisture | 46.7 | Oven drying |
| composition | Volatiles | 40.1 | Thermogravimetric |
| | Ash | 1.8 | analysis (TGA) |
| | Fixed carbon | 11.4 | |
| Elemental | C | 40.9 | CHNS elemental |
| composition | H | 6.3 | analyser |
| (dry basis) | O | 48.4 | |
| | N | 0.9 | |
| Lignocellulosic | Cellulose | 24.0 | Chemical |
| composition (dry | Hemicellulose | 50.8 | extraction |
| basis) | Lignin | 20.7 | |

Orange peel (OP), which is a type of fruit peel waste, was used as an active reducing agent for extraction of heavy metals from LIBs waste. Further characterization of OP such as reducing sugar measurements and antioxidant capacity measurements were conducted in Example 3.

### Example 3: Reducing Sugar and Antioxidant Capacity Measurements

The amount of reducing sugar in the OP samples was determined using the 3,5 dinitrosalicylic acid (DNS) method. To prepare the stock assay solution, DNS (1 g) was added to 2 ml of NaOH (2 M). The assay solution was then mixed with the OP sample solution (2:1 v/v) and boiled for 5 min. Reducing sugar-mediated conversion of the DNS into 3 amino, 5-nitrosalicylic acid can be determined spectroscopically at a maxima absorbance wavelength of 540 nm (Molecular Devices SpectraMax M2). The equivalent concentration of reducing sugars (equivalent to g/L glucose) of the OP samples was determined using glucose solutions with pre-determined concentrations as standards.

The antioxidant capacity (AC) of OP was determined using the ABTS assay kit (Beyotime). Prior to the measurement, a mixture of 2,2′-azino-bis(3-ethylbenzothiazoline-6-sulfonic acid) diammonium salt (ABTS) and oxidizer stock solution (1:1 v/v) was allowed to age in the dark at room temperature overnight. Next, the assay solution was prepared by diluting the mixture with PBS buffer with a dilution factor of 50. Trolox solutions of various concentrations (up to 0.2 mM) were prepared as per the manufacturer's protocol for normalization purpose. Readings were made on a 96 well format (Nunc™, Thermofisher). Each well contains 10 μl of sample or trolox solution, 200 μl of assay solution reconstituted in 1 M of citric acid (H₃Cit). After 10 min of vigorous shaking, the absorbance was measured with a high-throughput microplate reader (Molecular Devices SpectraMax M2) at a maxima absorbance wavelength of 734 nm. AC was computed and presented as “Antioxidant capacity (equivalent to mM Trolox)”.

### Example 4: Reductive Potential of Orange Peel (OP) Waste

The inventors postulate that the reducing capacity of OP can be attributed to two possible mechanisms of action. The first implicates the “reducing sugar theory”. When heated under acidic condition, about 30% of the cellulose could be degraded into glucose and over 70% of the hemicellulose could be rapidly converted into aldehyde-containing reducing sugars as xylose, arabinose, and mannose. Oxidation of glucose can produce polyhydroxyacids, formic, gluconic, aldonic and aldaric acids, aldoses, and carbon dioxide (CO₂).

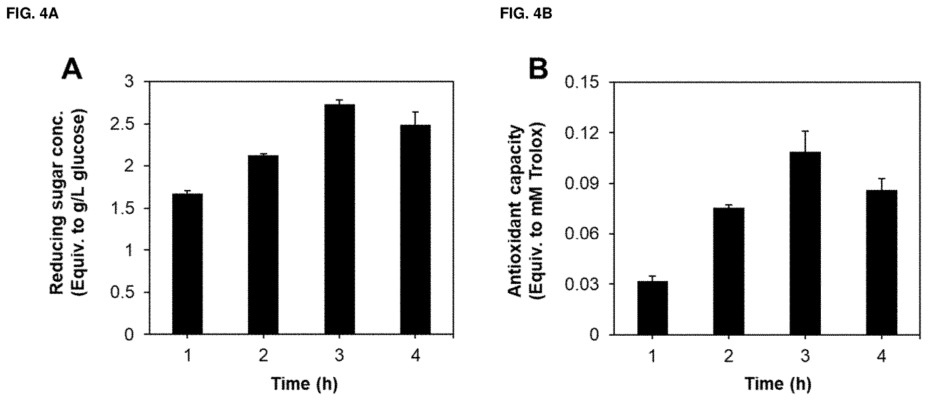

Using Example 3, the amount of reducing sugar and antioxidant capacity were measured. FIG. 4 and Table 2 show the time-course measurement of (A) reducing sugars and (B) antioxidant capacity of orange peel (OP) in H₃Cit (1 M) where the reaction conditions are as follows: Amount of OP: 200 g; and temperature: 90° C.

TABLE 2
Time-course measurement of (A) reducing sugars and (B)
antioxidant capacity of orange peel (OP) in H₃Cit (1M) where the
reaction conditions are as follows: Amount
of OP: 200 g; and temperature: 90° C..

| Time (Hours) | 1 | 2 | 3 | 4 |
|---|---|---|---|---|
| (A) Reducing sugar concentration | 1.7 | 2.1 | 2.8 | 2.5 |
| (equivalent to g/L | | | | |
| glucose) | | | | |
| (B) Antioxidant capacity (equivalent | 0.03 | 0.08 | 0.11 | 0.09 |
| to mM Trolox) | | | | |

FIG. 4A depicts the time-dependent production of reducing sugar by the OP samples at 90° C. in H₃Cit (1M). As early as 1 hour into the reaction, approximately 1.6 g/L equivalent concentration of glucose was detected in the reaction mix. The amount of reducing sugar continued to increase with reaction time and plateaus at 3-hour with approximately 2.7 g/L equivalent concentration of glucose. Secondly, in addition to its cellulosic-rich composition, another possible source of reducing components could stem from the presence of antioxidants such as phenolic acid and flavonoids, which could be hydrolysed into reducing substances. As shown in FIG. 4B, a steady increase in the antioxidant capacity (AC) of OP was observed from 1 hour onwards and the maximal AC of equivalent to 0.108 mM Trolox was obtained at around 3 hours. The slight decrease in the AC of the OP at 4 hours may be explained by the thermal instability of antioxidants, which could undergo structural decomposition when heated at 100° C. Therefore, these findings suggest that OP is a promising hydrogen peroxide (H₂O₂) substitute for hydrometallurgical processes as it contains numerous reducing constituents.

### Example 5: Reductive Leaching

Leaching performance of OP in either LCO or black mass was examined in H₃Cit lixiviant. All the leaching experiments were conducted in a 100 ml round-bottom flask under reflux (water as cooling agent) and stirring (350 rpm) condition. A volume of the leaching solution (40 ml) was applied to all the experimental groups. Upon completion of the leaching experiments, the samples were allowed to cool down for 20 minutes before they were drawn out and transferred into 50 ml centrifuge tubes.

Next, the residues were removed completely by ultra-centrifugation at 8500 rpm for 10 minutes and the lixiviant was additionally passed through a 450 nm polyvinylidene fluoride (PVDF) membrane filter to remove any solid residues. The filtered lixiviant samples were kept at 4° C. for further use.

To determine the ionic concentration of various metals in the lixiviant (1:500 dilution in deionized (DI) waster), inductively coupled plasma atomic emission spectroscopy (ICP-OES) was used. Aqua regia was used for normalization purpose. The leaching efficiency of each type of metal in the lixiviant can be calculated using the following expression:

$$Leaching efficiency ( \% ) ( Co , Li , Mn , Ni ) = \frac{Concentration of ( Co , Li , Mn , Ni ) in a sample}{Concentration of ( Co , Li , Mn , Ni ) in aqua regia} \times 100 \% \qquad Equation ( 4 )$$

### Example 6: Effect of Orange Peel (OP) and Temperature in Leaching Efficiency

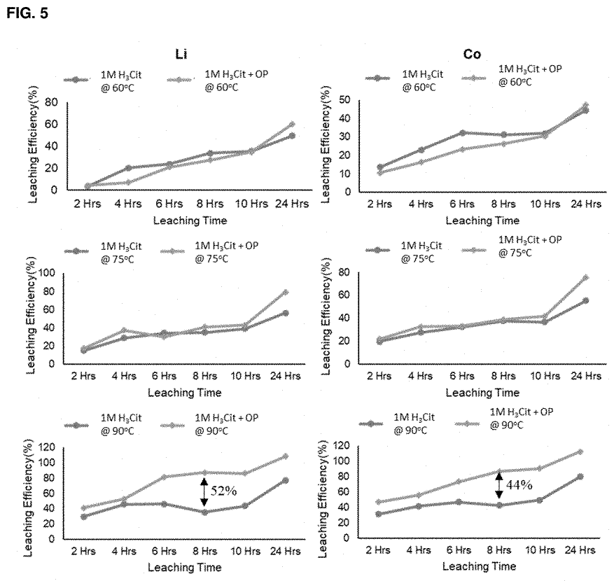

Having established the reducing properties of OP, the performance of OP as a leaching agent using LCO solution in H₃Cit lixiviant was next evaluated. Experimental group without the addition of OP serves as control. A study was conducted with fine orange peel (OP) powder (<250 um, obtained from the pre-processing and preparation from Example 2). Small OP particulates have a larger surface area and demonstrate to be more effective in interacting with LIBs waste during the metal extraction process. Results showed that addition of OP to the citric acid significantly elevated the leaching efficiency (more than 20%) of both Co and Li in pure LiCoO₂ materials at a reaction temperature of 90° C. (FIG. 5).

FIG. 5 and Table 3 show the time-dependent leaching efficiency of (A) Co and (B) Li in LCO solution (LiCoO₂) using either H₃Cit (0) or H₃Cit+OP (0) containing lixiviant at different temperatures (60° C., 75° C., and 90° C.), where the leaching conditions are as follows: 40 ml of H₃Cit (1 M), OP=200 mg; LCO=500 mg. Data are presented as mean±standard deviation.

As shown in FIG. 5, without the addition of OP and at a temperature of 90° C., the leaching efficiency of Li and Co from LCO increased with time but only managed to peak at 77% and 80% respectively at 24 hours into the experiment. In contrast, the leaching efficiencies of Li and Co in the OP-containing lixiviant were clearly enhanced at each time-step relative to the H₃Cit only group. Maximal increment in leaching efficiency of approximately 87% for Li and 87% for Co for the OP+H₃Cit group at a temperature of 90° C. occurs at the 8-hour mark. By 24-hour, complete (100%) leaching of both metallic ions was observed in the OP+H₃Cit group.

Furthermore, as shown in FIG. 5, the leaching efficacy was dependent on the reaction temperature (60° C., 75° C., and 90° C.). Specifically, leaching efficiency of Co and Li was increased from 50% and 60% respectively at 60° C. to 100% at 90° C.

TABLE 3
Measurements of time-dependent leaching efficiency of (A) Co and (B) Li in LCO
solution (LiCoO₂) using either H3Cit (Δ) or H₃Cit + OP (∘) containing lixiviant at different
temperature (60° C., 75° C., and 90° C.) where the leaching conditions are as follows: 40 ml of
H₃Cit (1 M), OP = 200 mg; LCO = 500 mg.

| Leaching Efficiency | | Lithium (Li) | | | | | |
|---|---|---|---|---|---|---|---|
| Temperature | Time (Hours) | 2 | 4 | 5 | 8 | 10 | 24 |
| 60° C. | 1M H₃Cit | 4 | 20 | 24 | 34 | 36 | 50 |
| | 1M H₃Cit + OP | 4 | 7 | 21 | 28 | 35 | 60 |
| 75° C. | 1M H₃Cit | 15 | 29 | 34 | 35 | 39 | 56 |
| | 1M H₃Cit + OP | 17 | 37 | 30 | 41 | 43 | 79 |
| 90° C. | 1M H₃Cit | 30 | 46 | 46 | 35 | 44 | 77 |
| | 1M H₃Cit + OP | 41 | 53 | 82 | 87 | 86 | 100 |
| Leaching Efficiency | | Cobalt (Co) | | | | | |
| Temperature | Time (Hours) | 2 | 4 | 5 | 8 | 10 | 24 |
| 60° C. | 1M H₃Cit | 14 | 23 | 32 | 32 | 32 | 45 |
| | 1M H₃Cit + OP | 11 | 16 | 23 | 26 | 30 | 47 |
| 75° C. | 1M H₃Cit | 20 | 28 | 32 | 38 | 37 | 55 |
| | 1M H₃Cit + OP | 22 | 33 | 33 | 39 | 42 | 76 |
| 90° C. | 1M H₃Cit | 31 | 42 | 47 | 43 | 50 | 80 |
| | 1M H₃Cit + OP | 47 | 56 | 73 | 87 | 90 | 100 |

### Example 7: Comparison of Leaching Efficiency Between Orange Peel and d-Glucose

To investigate whether the active components that assists in extracting valuable metals from LIBs waste are a mixture of reducing sugars that are derived from the crude fibers in orange peel (OP), a study was conducted to compare the leaching efficiency of d-glucose with the same amount to that of OP along with establishing the baseline by using only citric acid (H₃Cit) as a negative control.

TABLE 4
Comparison of the leaching efficiency of Co and
Li in LiCoO₂ between using orange
peel (OP) and d-glucose with the same mass.

| Leaching Efficiency (%) | Cobalt (Co) | Lithium (Li) |
|---|---|---|
| H₃Cit | 44 | 41 |
| H₃Cit + Orange Peel (OP) | 63 | 67 |
| H₃Cit + Glucose (Glu) | 58 | 58 |

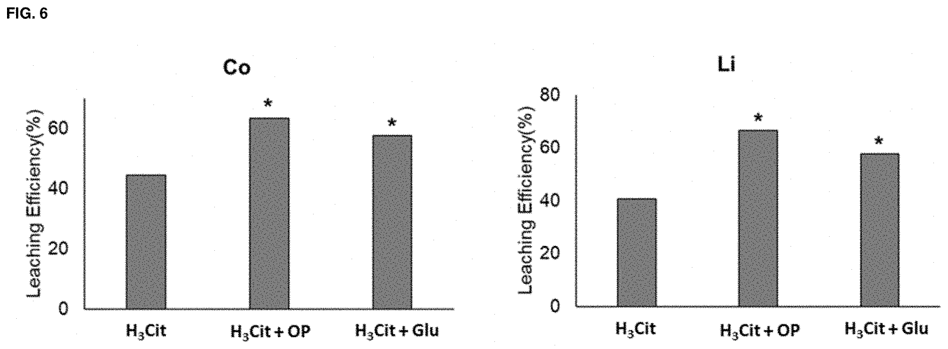

Interestingly, as shown in FIG. 6 and Table 4, while d-glucose significantly enhanced leaching efficiency of both Li and Co, it performed slightly worse than OP (58% vs 63% in Co, 58% vs 67% in Li). This implies that d-glucose can only in part explain the seen improvement from OP. One plausible explanation from these results could be the significant contribution by the antioxidants being produced from OP during the leaching process. Hence, results as shown in FIG. 6 and Table 4 demonstrate the excellent reducing power of OP and this can be attributed to its crude fiber (cellulose, hemicellulose, lignin, etc.) from the orange peel and derived monosaccharides (e.g. d-glucose).

### Example 8: Leaching Efficiency of Various Metals in Black Mass Using Orange Peel

To further verify that the high leaching efficiency can be achieved not only in pure LiCoO₂ (LCO) but also in a similar fashion in real LIBs waste sample, a study was conducted on black mass (pre-processed and prepared from Example 1, obtained directly from LIBs waste).

In terms of chemical composition, black mass is far more complex compared to the LCO sample. ICP-OES analysis of the elemental composition of the black mass revealed that apart from Li (4.7 w %) and Co (35.5 w %), other metallic constituents such as Mn (2.1 w %), Ni (3.1 w %), Al (1.7%), and Cu (1.4%) were also found to be present in the complex waste materials. The Al and Cu ions are most likely to originate from the current collectors.

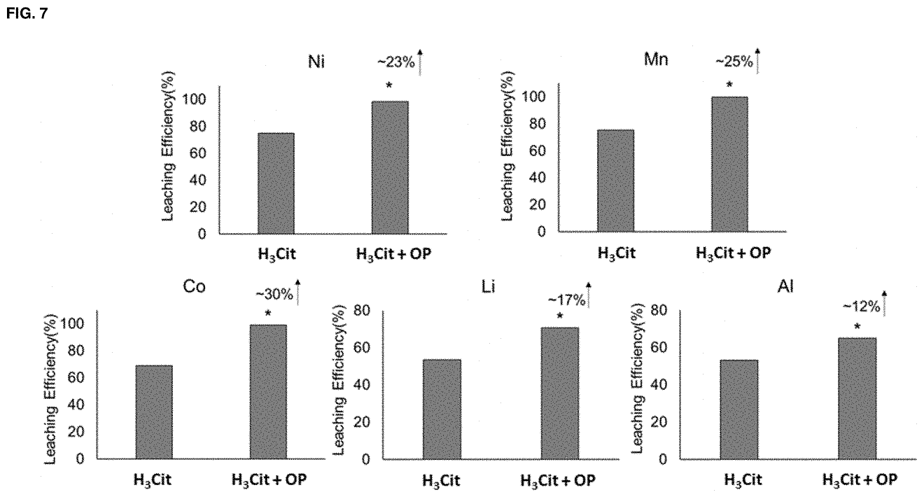

FIG. 7 and Table 5 show the leaching efficiencies of the main cathode materials (i.e. Ni, Mn, Co, Li and Al) in the LIBs black mass sample. In the H₃Cit only group, the leaching efficiencies of the various metals vary and are limited to <80% regardless of the identity of the metal.

TABLE 5
Comparison of the leaching efficiency of
various metals Ni, Mn, Co, Li and Al in
lithium-ion batteries (LIBs) black mass-containing
lixiviant using either H₃Cit or H₃Cit + OP.
Leaching conditions are as follows: H₃Cit (1M),
lixiviant volume = 40 ml, OP = 200 mg, LCO =
500 mg, black mass = 200 mg, leaching
temperature = 90 ° C., and leaching duration = 7 h.

| Leaching | Nickel | Manganese | Cobalt | Lithium | Aluminium |
|---|---|---|---|---|---|
| Efficiency (%) | (Ni) | (Mn) | (Co) | (Li) | (Al) |
| H₃Cit | 75 | 75 | 69 | 53 | 53 |
| H₃Cit + Orange | 98 | 100 | 99 | 70 | 65 |
| Peel (OP) | | | | | |
| Difference | 23 | 25 | 30 | 17 | 12 |
| [(H₃Cit + OP) − | | | | | |
| (H₃Cit)] | | | | | |

Conversely, the addition of OP to the lixiviant resulted in a substantial increase in the amount of extracted metals by ˜17-30% (FIG. 7 and Table 5). Except for Li, which has a leaching efficiency of ˜70%, a near 100% recovery of Co, Ni and Mn could be achieved from the OP and H₃Cit containing lixiviant. The varied degree to which the improvement was seen in each metallic component could be partially accounted by the difference of reactivity of each metal with OP in citric acid environment. Taken together, these results show and suggest that OP with a size of less than 250 μm can facilitate the metal extraction in pure LiCoO₂ (LCO) as well as black mass, thereby showcasing its great potential in being exploited as a potent and green reductant that can be used in the future market of LIB waste recycling with an aim to proceed to a zero-waste society.

### Example 9: Leaching Efficiency of Various Metals Using Different Types of Fruit Peels

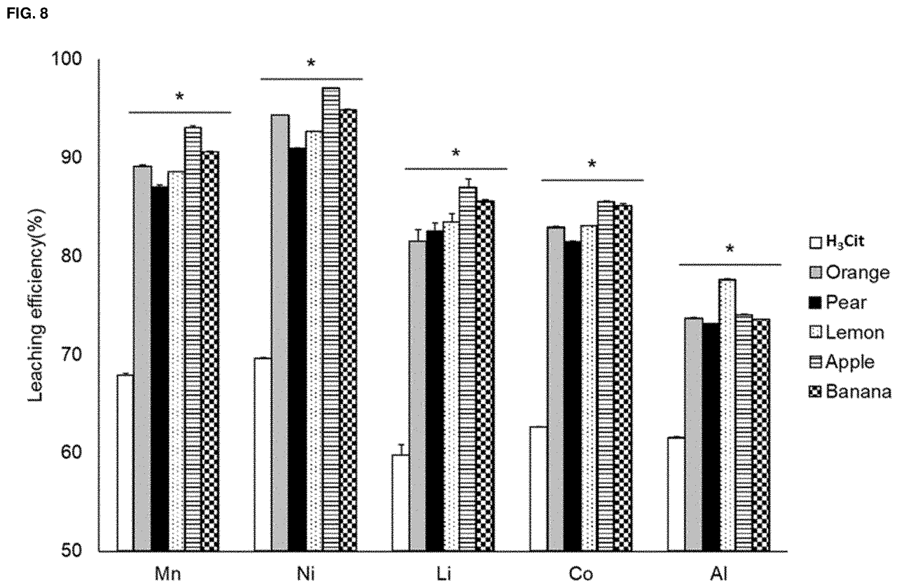

To demonstrate that the utility of fruit peel waste for metal extraction process is not confined to merely orange peel (OP), several dry fruit peel powders were harvested from pear, lemon, apple, and banana with the same protocol as described earlier in Example 2 and FIG. 3. The leaching experiments at the same conditions with the study of the OP were conducted for these four different types of fruit peel waste. The leaching efficiency of various metals (Mn, Ni, Li, Co and Al) in black mass using citric acid only or citric acid with different individual types of fruit peel waste (e.g. fruit skin) is illustrated and tabulated in FIG. 8 and Table 6 respectively.

TABLE 6
leaching efficiency of various metals (Mn, Ni, Li,
Co and Al) in black mass using citric acid only or
citric acid with different individual types of fruit peel waste.

| Leaching | Manganese | Nickel | Lithium | Cobalt | Aluminium |
|---|---|---|---|---|---|
| Efficiency (%) | (Mn) | (Ni) | (Li) | (Co) | (Al) |
| H₃Cit | 68 | 70 | 60 | 63 | 62 |
| H₃Cit + Orange | 89 | 94 | 81 | 83 | 74 |
| Peel/Skin | | | | | |
| H₃Cit + Pear | 87 | 91 | 83 | 81 | 78 |
| Peel/Skin | | | | | |
| H₃Cit + Lemon | 88 | 93 | 83 | 83 | 78 |
| Peel/Skin | | | | | |
| H₃Cit + Apple | 93 | 97 | 87 | 86 | 74 |
| Peel/Skin | | | | | |
| H₃Cit + Banana | 91 | 95 | 86 | 85 | 74 |
| Peel/Skin | | | | | |

As observed in FIG. 8 and Table 6, a similar improvement was observed in all the fruit peel waste groups as compared to the citric acid only group (H₃Cit). This suggests that the hypothesis on the fundamental cause of OP-led improvement (i.e. reducing sugars as well as antioxidants in OP assists metals to be leached out from the batteries waste), can be expanded to many other crude fiber-rich and antioxidants-rich food waste.

One interesting observation to note is that although the five fruit peels (orange, pear, lemon, apple and banana) performed similarly to increase the leaching efficiency of various metals, it seems that apple peels had the best performance over the rest. This may imply that the composition of waste is of vital importance as different types of reducing sugars and antioxidants tend to possess uneven reactivity with metals in citric acid condition. Therefore, the composition of each type of peels, especially the quantity of antioxidants and reducing sugars, should be characterized in the future to better address the reactivity difference between each fruit peel waste. By extension, it is also possible to use mixed fruit peel waste for such application.

### Example 10: Leaching Efficiency of Various Metals in Black Mass with Actual Food Waste

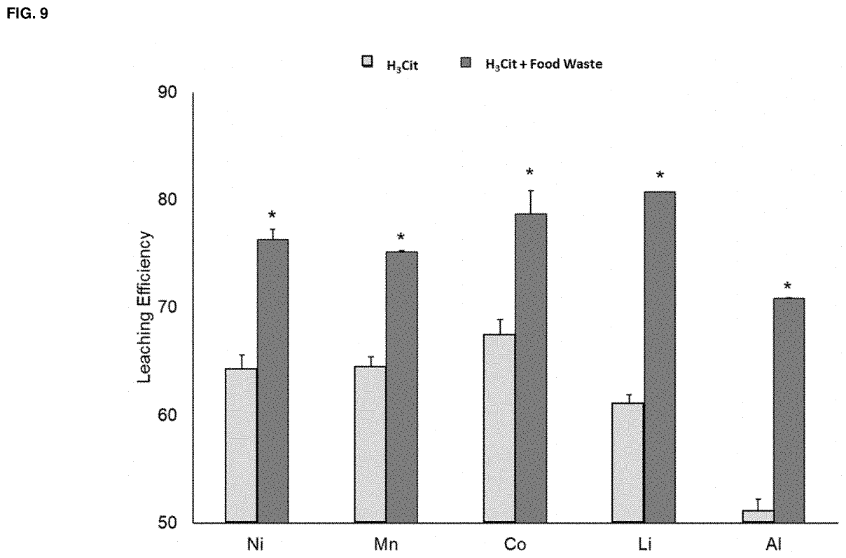

To further address the feasibility of translating the laboratory-proven concept of using fruit peel waste to recycle battery wastes (e.g. LIBs) into the real recycling industry, fruit peel waste (i.e. waste that mainly contains fruit skins and leftover flesh) was collected from a fruit juice store at one of the campus canteens in Nanyang Technological University (NTU), Singapore. The as-collected waste was further processed into dry powder using the similar protocol as discussed in Example 2 and FIG. 3. The leaching experiments were repeated, and it was found that there was a significant improvement on metal leaching extraction in the group of citric acid and fruit peel waste as compared to the control group where only citric acid existed. Leaching efficiency of various metals in black mass with actual food waste (w/w=1) in citric acid (H₃Cit, 1M) is tabulated and shown in Table 7 and FIG. 9.

TABLE 7
Comparison of the leaching efficiency of various
metals Ni, Mn, Co, Li and Al in black mass with actual
food waste (w/w = 1) in H₃Cit or H₃Cit + food waste.

| Leaching Efficiency | Nickel | Manganese | Cobalt | Lithium | Aluminium |
|---|---|---|---|---|---|
| (%) | (Ni) | (Mn) | (Co) | (Li) | (Al) |
| H₃Cit | 64 | 64 | 67 | 61 | 51 |
| H₃Cit + Food Waste | 76 | 75 | 79 | 81 | 71 |
| Difference | 12 | 11 | 12 | 20 | 20 |
| [(H₃Cit + Food | | | | | |
| waste) − (H₃Cit)] | | | | | |

The consistent improvement regardless of the type of waste further support the concept of the present disclosure of using fruit peel waste to enhance metal recovery from the battery waste. Further, it can generally apply to any kind of food waste that is known to be rich in crude fiber. Taken together, the preliminary data showcase the disclosed waste to resource technology and more experiments need to be completed to realize the actual translation and application of this concept into real business (e.g. large scale application).

### Example 11: Optimization of OP-Mediated Leaching Conditions

The effects of several parameters were systematically examined and correlated to the leaching efficiency of the different metals in the black mass containing lixiviant.

Effect of Reductant Amount

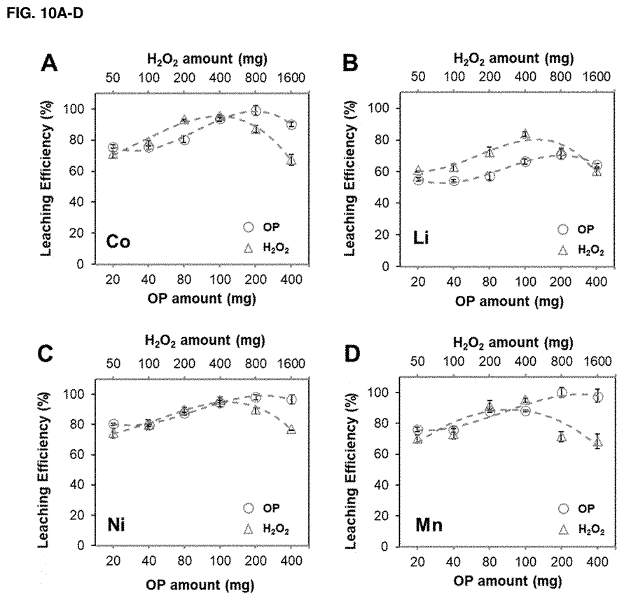

The effect of varying the amount of OP reductant on the leaching experiments was first examined. Hydrogen peroxide (H₂O₂), a widely used reductant in the metal extraction process was employed as a basis of comparison. The amount of the OP and H₂O₂ was varied from 20-400 mg and 50-1600 mg per batch of reaction respectively. The results of the effect of reductant amount (orange peel and H₂O₂ is observed in Table 8 and FIG. 10.

TABLE 8
Effect of reductant amount on the leaching efficiency of
(A) Co, (B) Li, (C) Ni and (D) Mn in LIBs black mass-containing
lixiviant using either OP or H₂O₂ as the reductant.
(A) Cobalt (Co)

| | Leaching | Amount | Leaching |
|---|---|---|---|
| Amount | Efficiency (%) − | of H₂O₂ | Efficiency (%) − |
| of OP (mg) | OP as reductant | (mg) | H₂O₂ as reductant |
| 20 | 75 | 50 | 71 |
| 40 | 76 | 100 | 79 |
| 80 | 80 | 200 | 93 |
| 100 | 94 | 400 | 96 |
| 200 | 99 | 800 | 87 |
| 400 | 90 | 1600 | 68 |

(B) Lithium (Li)

| | Leaching | Amount | Leaching |
|---|---|---|---|
| Amount of | Efficiency (%) − | of H₂O₂ | Efficiency (%) − |
| OP (mg) | OP as reductant | (mg) | H₂O₂ as reductant |
| 20 | 55 | 50 | 61 |
| 40 | 55 | 100 | 63 |
| 80 | 57 | 200 | 72 |
| 100 | 67 | 400 | 84 |
| 200 | 71 | 800 | 73 |
| 400 | 64 | 1600 | 61 |

(C) Nickel (Ni)

| | Leaching | Amount | Leaching |
|---|---|---|---|
| Amount of | Efficiency (%) − | of H₂O₂ | Efficiency (%) − |
| OP (mg) | OP as reductant | (mg) | H₂O₂ as reductant |
| 20 | 81 | 50 | 75 |
| 40 | 80 | 100 | 80 |
| 80 | 88 | 200 | 90 |
| 100 | 94 | 400 | 96 |
| 200 | 98 | 800 | 90 |
| 400 | 97 | 1600 | 77 |

(D) Manganese (Mn)

| | Leaching | Amount | Leaching |
|---|---|---|---|
| Amount | Efficiency (%) − OP | of H₂O₂ | Efficiency (%) − |
| of OP (mg) | as reductant | (mg) | H₂O₂ as reductant |
| 20 | 76 | 50 | 70 |
| 40 | 76 | 100 | 73 |
| 80 | 88 | 200 | 92 |
| 100 | 88 | 400 | 96 |
| 200 | 100 | 800 | 72 |
| 400 | 98 | 1600 | 68 |

In general, as shown in FIG. 10 and Table 8, the leaching efficiency increased with increasing amount of OP and H₂O₂. For the H₂O₂ group, optimal dissolution of the metals was observed with 400 mg (1% v/v) of reductant. As shown in FIG. 10, more than 90% of Co, Mn and Ni, and approximately 80% of Li could be recovered at this concentration (400 mg 1% v/v).

However, at higher amount of H₂O₂, a drastic decrease was observed in the leaching efficiencies for all the metals by as much as 20%. This could be attributed to the concentration-dependent self-decomposition of H₂O₂ which will severely decrease the availability of the reductant (i.e. H₂O₂) in the leaching solution. In the case of the OP group, maximal leaching efficiency of Co (98.9%), Li (72.5%), Ni (98.2%) and Mn (99.8%), and recovery was observed with 200 mg of OP powder. However, in contrast to the H₂O₂ group, metal leaching efficiencies did not decrease but plateaued at a near-maximal with increasing OP concentration. Hence, the optimal amount of orange peel (reductant) is 200 mg and the optimal amount of H₂O₂ is 400 mg. It should be highlighted that in terms of the leaching efficiency, the potency of both reductants is on par, even if the mass of H₂O₂ is at several-fold higher than the mass of OP used.

Effect of Leaching Temperature

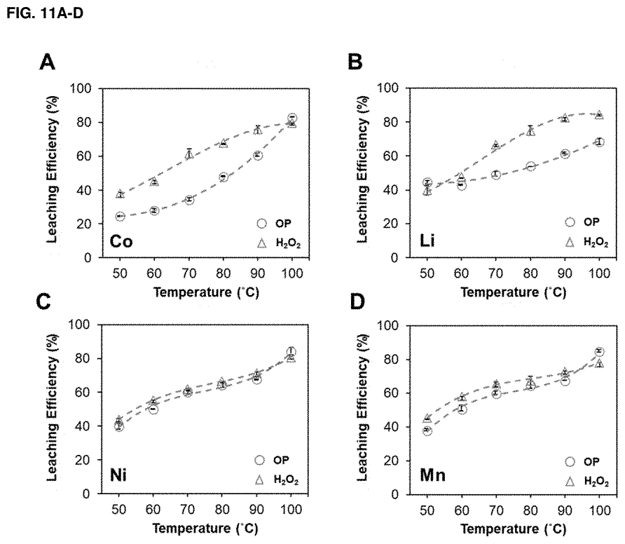

Having established the optimal amount of reductant (i.e. OP=200 mg and H₂O₂=400 mg) as shown above, the effect of temperature on the leaching process was next examined. Temperature has important bearing on the thermodynamics and kinetics of the metal leaching process. FIG. 11 and Table 9 show the leaching efficiencies of both reductants for Co, Li, Mn and Ni over a reaction temperature range of 50-100° C. and a reaction time of 4-hour.

TABLE 9
Effect of leaching temperature on the leaching
efficiency of (A) Co, (B) Li, (C) Ni and
(D) Mn in LIBs black mass-containing lixiviant
using either OP or H₂O₂ as the reductant.
(A) Cobalt (Co)

| Leaching | Leaching | Leaching |
|---|---|---|
| Temperature | Efficiency (%) − | Efficiency (%) − |
| (° C.) | OP as reductant | H₂O₂ as reductant |
| 50 | 25 | 38 |
| 60 | 28 | 45 |
| 70 | 34 | 62 |
| 80 | 48 | 68 |
| 90 | 61 | 76 |
| 100 | 83 | 80 |

(B) Lithium (Li)

| Leaching | Leaching | Leaching |
|---|---|---|
| Temperature | Efficiency (%) − | Efficiency (%) − |
| (° C.) | OP as reductant | H₂O₂ as reductant |
| 50 | 45 | 40 |
| 60 | 43 | 48 |
| 70 | 49 | 67 |
| 80 | 54 | 75 |
| 90 | 61 | 83 |
| 100 | 68 | 85 |

(C) Nickel (Ni)

| Leaching | Leaching | Leaching |
|---|---|---|
| Temperature | Efficiency (%) − | Efficiency (%) − |
| (° C.) | OP as reductant | H₂O₂ as reductant |
| 50 | 40 | 44 |
| 60 | 50 | 55 |
| 70 | 60 | 62 |
| 80 | 64 | 67 |
| 90 | 68 | 72 |
| 100 | 84 | 81 |

(D) Manganese (Mn)

| Leaching | Leaching | Leaching |
|---|---|---|
| Temperature | Efficiency (%) − | Efficiency (%) − |
| (° C.) | OP as reductant | H₂O₂ as reductant |
| 50 | 38 | 45 |
| 60 | 51 | 58 |
| 70 | 60 | 66 |
| 80 | 64 | 67 |
| 90 | 67 | 73 |
| 100 | 85 | 78 |

Increasing the leaching temperature led to a progressive and considerable increase in the leaching efficiency for all the metallic ions regardless of reductant type. When the leaching temperature was increased from 50° C. to 100° C., a corresponding increase of 55%, 25%, 41% and 47% for Co, Li, Ni, and Mn was observed respectively Specifically, at the leaching temperature of 100° C., 82% of Co, 68% of Li, 84% of Ni and 84% of Mn was found to be leached into the lixiviant. Therefore, with the other parameters kept constant, it can be concluded that 100° C. would be the ideal temperature to maximize the leaching capacity of OP.

Effect of Acid Concentration

Acid concentration is a critical determinant of the leaching process. In the proposed leaching systems, an acidic milieu can potentially favour the redox reaction to generate different forms of metallic ions as shown in Equation 5.

Black mass(s)+H₃Cit(aq)+OP(s)/H₂O₂(l)→Co²⁺+Li⁺+Mn²⁺+Ni²⁺+Cit³⁻+Hcit²⁻+H₂Cit⁻ Equation (5)

Additionally, increasing the ionic strength of the lixiviant is also postulated to promote the decomposition of cellulose and hemicellulose found in the OP into reducing sugars, thereby aiding the leaching process.

TABLE 10

| Effect of acid concentration on the leaching efficiency of | | |
|---|---|---|
| (A) Co, (B) Li, (C) Ni and (D) Mn in LIBs black mass-containing | | |
| lixiviant using either OP or H₂O₂ as the reductant. | | |
| (A) Cobalt (Co) | | |
| Citric Acid | Leaching | Leaching |
| Concentration | Efficiency (%) − | Efficiency (%) − |
| (M) | OP as reductant | H₂O₂ as reductant |
| 0.1 | 78 | 60 |
| 0.5 | 81 | 81 |
| 1.0 | 83 | 88 |
| 1.5 | 90 | 98 |
| 2.0 | 87 | 88 |

(B) Lithium (Li)

| Citric Acid | Leaching | Leaching |
|---|---|---|
| Concentration | Efficiency (%) − | Efficiency (%) − |
| (M) | OP as reductant | H₂O₂ as reductant |
| 0.1 | 67 | 80 |
| 0.5 | 69 | 83 |
| 1.0 | 69 | 87 |
| 1.5 | 76 | 92 |
| 2.0 | 75 | 83 |

(C) Nickel (Ni)

| Citric Acid | Leaching | Leaching |
|---|---|---|
| Concentration | Efficiency (%) − | Efficiency (%) − |
| (M) | OP as reductant | H₂O₂ as reductant |
| 0.1 | 66 | 38 |
| 0.5 | 82 | 78 |
| 1.0 | 87 | 96 |
| 1.5 | 100 | 99 |
| 2.0 | 94 | 90 |

(D) Manganese (Mn)

| Citric Acid | Leaching | Leaching |
|---|---|---|
| Concentration | Efficiency (%) − | Efficiency (%) − |
| (M) | OP as reductant | H₂O₂ as reductant |
| 0.1 | 75 | 74 |
| 0.5 | 94 | 94 |
| 1.0 | 86 | 90 |
| 1.5 | 100 | 88 |
| 2.0 | 98 | 94 |

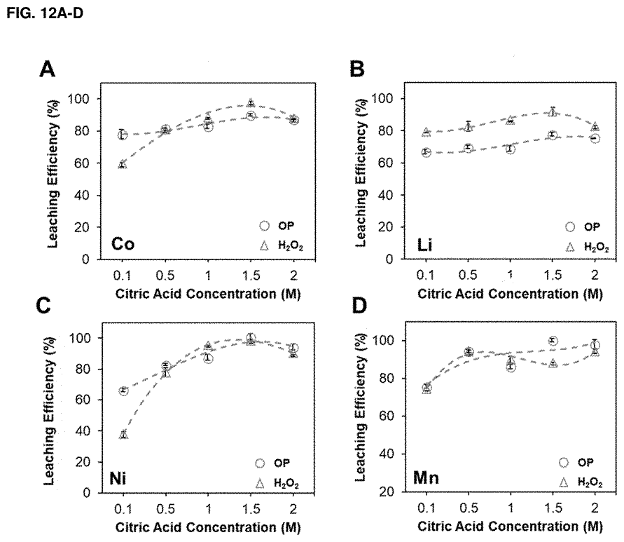

FIG. 12 and Table 10 show the plot of leaching efficiency with increasing concentration of H₃Cit from 0.1-2.0 M. Highest amount of extracted Co (89%,), Li (76%), Ni (100%) and Mn (100%) occurs when 1.5 M of H₃Cit was used with OP as the reductant. Interestingly, dissolved fraction of Co and Li only improved by about 10% when H₃Cit was increased from 0.2-1.5 M. Comparatively, higher concentration of H₃Cit leads to about 25-35% enhancement in Ni and Mn leaching. However, leaching efficiency of these metals began to plateau off or decline slightly in both the OP and H₂O₂-based leaching system when the concentration of H₃Cit was increased from 1.5 M-2.0 M.

A possible explanation could be attributed to formation of insoluble metallic citrates (e.g. Co₃Cit₂) when H₃Cit is added in excess (Equation 6). Therefore, increasing the H₃Cit concentration to a certain extent is likely to result in the observed level-off or decline of leaching efficiency by the salting-out effects.

MₓH_{y}Cit_{z}(S)↔M^{a+}+Cit³⁻+Hcit²⁻+H₂Cit⁻ Equation (6)

where M denotes a metal (Mn/Ni/Co/Li); subscript x, y, z denotes the number of the element in the molecule; and superscript a denotes the valency of the different metals.

Effect of Slurry Density

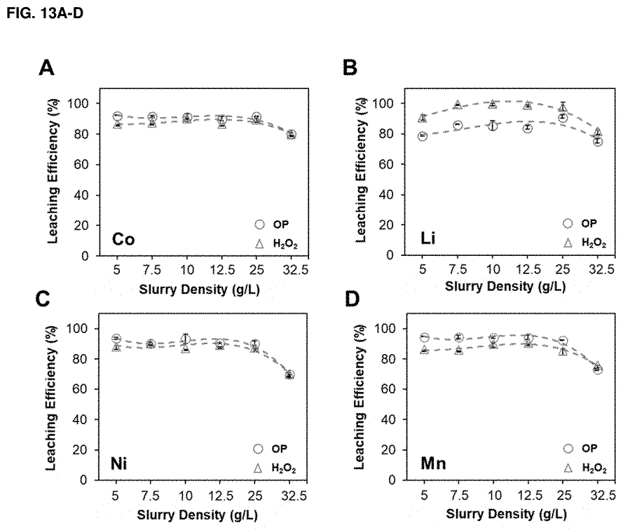

Slurry density was varied by controlling the black mass to the leaching liquid ratio. The results of the effect of the slurry density on the leaching efficiency is tabulated in Table 11 and FIG. 13.

TABLE 11
Effect of slurry on the leaching efficiency of
(A) Co, (B) Li, (C) Ni and (D) Mn in LIBs
black mass-containing lixiviant using either
OP or H₂O₂as the reductant.
(A) Cobalt (Co)

| | Leaching | Leaching |
|---|---|---|
| Slurry | Efficiency (%) − | Efficiency (%) − |
| Density (g/L) | OP as reductant | H₂O₂ as reductant |
| 5.0 | 92 | 86 |
| 7.5 | 92 | 87 |
| 10.0 | 91 | 90 |
| 12.5 | 90 | 87 |
| 25.0 | 91 | 90 |
| 32.5 | 80 | 80 |

(B) Lithium (Li)

| | Leaching | Leaching |
|---|---|---|
| Slurry | Efficiency (%) − | Efficiency (%) − |
| Density (g/L) | OP as reductant | H₂O₂ as reductant |
| 5.0 | 78 | 91 |
| 7.5 | 86 | 99 |
| 10.0 | 85 | 100 |
| 12.5 | 84 | 99 |
| 25.0 | 91 | 98 |
| 32.5 | 75 | 82 |

(C) Nickel (Ni)

| | Leaching | Leaching |
|---|---|---|
| Slurry | Efficiency (%) − | Efficiency (%) − |
| Density (g/L) | OP as reductant | H₂O₂ as reductant |
| 5.0 | 93 | 88 |
| 7.5 | 90 | 90 |
| 10.0 | 93 | 87 |
| 12.5 | 90 | 89 |
| 25.0 | 90 | 88 |
| 32.5 | 70 | 70 |

(D) Manganese (Mn)

| | Leaching | Leaching |
|---|---|---|
| Slurry | Efficiency (%) − | Efficiency (%) − |
| Density (g/L) | OP as reductant | H₂O₂ as reductant |
| 5.0 | 94 | 86 |
| 7.5 | 95 | 86 |
| 10.0 | 94 | 90 |
| 12.5 | 94 | 90 |
| 25.0 | 92 | 85 |
| 32.5 | 73 | 76 |

The slurry density has marginal effect on the leaching efficiency in both the OP and H₂O₂ group till a concentration of 25 g/L. Despite the relative high slurry density, the leaching efficiency in the OP group was more than 90%. However, when the slurry density was further increased from 25 g/L to 32.5 g/L, there was a significant decrease (about 15%) in the leaching efficiency for all the metallic ions probed. These findings showed that slurry densities ranging from 15 to 30 g/L were favourable for leaching of cathode materials. In addition, the results also suggest that beyond the slurry density of 25 g/L, the amount of H₃Cit and OP may be limiting.

Taken together, these findings revealed that the combination of the various parameters: 200 mg of OP, leaching temperature of 100° C., H₃Cit (1.5 M), leaching duration of 4 hours and slurry density of 25 g/L could significantly augment the leaching efficiency of the OP-enable hydrometallurgy. With this set of conditions, Co (91.3%), Li (80.5%), Ni (90.1%) and Mn (92.2%) was recovered from the black mass lixiviant. This set of conditions can serve as a baseline condition for future scale-up and optimization.

### Example 12: Characterization and Toxicity Evaluation of by-Products Derived from the Leaching Process

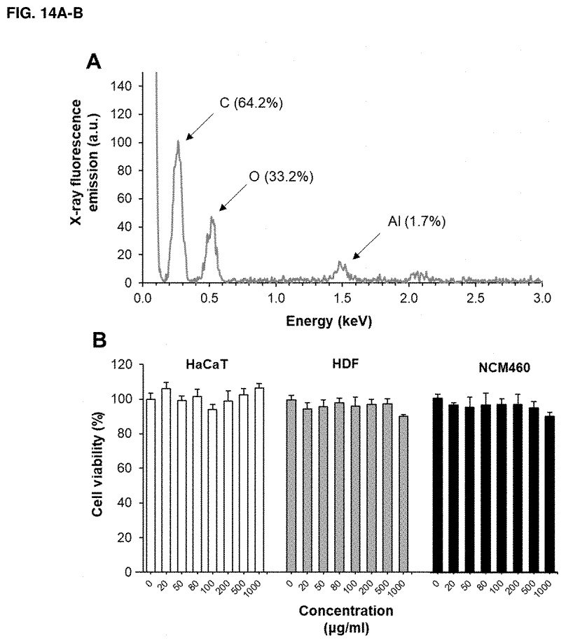

The sustainable utilization of OP-enabled hydrometallurgy would also require that the generated side-streams be environmentally friendly and safe. The elemental composition of the residual materials was first determined using energy-dispersive X-ray spectroscopy (EDX). As can be seen in FIG. 14A, the X-ray fluorescence spectrum indicate that the solid by-products contain largely C (64.2%), 0 (33.3%), and trace amount of Al (1.6%), suggesting that the residue is likely to originate from the anode (graphite) and OP waste (organic compounds).

Since the impact of these materials on human health is one key reflection of their environmental footprints, the toxic potential of the solid residues was evaluated using the alamarBlue assay in three different human cell lines, namely, (i) human keratinocytes (HaCaTs), (ii) normal human colon mucosal epithelial cell or human colorectal cells (NCM460) and (iii) human dermal fibroblasts (HDF). Briefly, the solid residues after the leaching step were recovered, oven-dried (80° C.), and resuspended in water at 3 mg/ml (stock solution) by ultrasonication. To ensure sterility, the solution was kept under UV light (0.9 W) for 2 hours prior to use. Cells were seeded overnight to reach 70% confluency before the samples were treated with the leaching residues at various concentrations (of 20, 50, 80, 100, 200, 500, 1000 μg/ml) for 24 hours. Cell viability was determined spectroscopically with fluorescence readout at excitation/emission wavelength of 530/590 nm (Molecular Devices SpectraMax M2).

TABLE 12
Cell viability (%) of three different human cell lines,
namely, (i) human keratinocytes
(HaCaTs), (ii) human colorectal cells (NCM460) and
(iii) human dermal fibroblasts (HDF) when exposed to solid
residues at concentrations ranging from 0-1000 μg/ml.

| Cell viability (%) | | | |
|---|---|---|---|
| when exposed to solid | | | |
| residues at concentrations | | | |
| ranging from 0-1000 μg/ml | Human Cell Lines | | |
| Concentration | | | (iii) human |
| of solid | (i) human | (ii) human | dermal |
| residues | keratinocytes | colorectal cells | fibroblasts |
| (μg/ml) | (HaCaTs) | (NCM460) | (HDF) |
| 0 | 100 | 100 | 100 |
| 20 | 106 | 96 | 95 |
| 50 | 99 | 95 | 96 |
| 80 | 101 | 96 | 98 |
| 100 | 93 | 96 | 96 |
| 200 | 98 | 96 | 97 |
| 500 | 102 | 94 | 97 |
| 1000 | 106 | 90 | 90 |

FIG. 14B and Table 12 shows the dose response graph of the respective cells that were exposed to the leachate solid waste ranged 0-1000 μg/ml. Remarkably, the cytotoxic potential of the by-products was negligible in all the tested cell lines, even at the extreme concentration of 1000 μg/ml. This suggests that the carbonaceous by-product is non-toxic and by extension, its environmental impact should be minimal. Nevertheless, to better evaluate the long-term environmental impact of the OP leaching-derived carbonaceous by-product, other chemical analysis such as Toxicity Characteristic Leaching Procedure (TCLP) can be employed to simulate the leaching process in the landfill setting.

### Example 13: In Situ Precipitation of Metal Hydroxides (Recovery of Co)

To assess the applicability of the OP-enabled hydrometallurgy to the LIBs recycling industry, Co was retrieved from the OP leaching liquor with the aim to be subsequently used to generate new batches of LCO batteries. To prepare the leaching solution, 5 g black mass and 1 g OP were mixed with 100 ml 1.5M H₃Cit and allowed to react for 4 hours at 100° C. Following which, the leaching solution was centrifuged at 8500 rpm for 10 minutes. To remove the solid residues, the supernatant was then filtered using a 0.22 μm filter membrane (Nalgene®, Thermo Scientific).

A two-step NaOH induced precipitation protocol was employed to retrieve cobaltous hydroxide (recover cobalt (Co) from the black mass leachate by forming cobalt (I I/III) hydroxide (Kₛₚ=5.92×10⁻¹⁵ and 1.6×10⁻⁴⁴, respectively)). In the first step, the pH of the leachate was adjusted to 12 using NaOH to induce rapid precipitation and removal of Mn(OH)₂ and Ni(OH)₂.

Upon completion of the pH adjustment, the solution was immediately placed in the oven at the temperature of 80° C. for 30 minutes. At this pH, the precipitation of Cu(OH)₂ and Al(OH)₃ are largely prohibited due to the amphoteric nature of the two hydroxides, which makes them soluble in highly alkaline condition. Thereafter, in the second step, the Co-rich lixiviant was subjected to another round of precipitation using ethanol (100%, vₑₜₕₐₙₒₗ/vₛᵤₚₑᵣₙₐₜₐₙₜ=1:10) to recover cobalt hydroxide at the temperature of 80° C. overnight.

The solid content was then washed amply by water, collected by centrifugation at 8500 rpm for 10 min, and dried in the oven at 60° C. overnight. The chemical characteristics of the recovered precipitate was further examined using energy-dispersive X-ray spectroscopy (EDX) analysis.

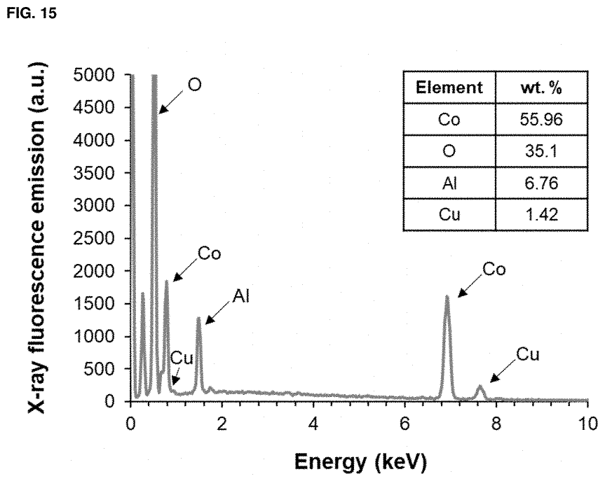

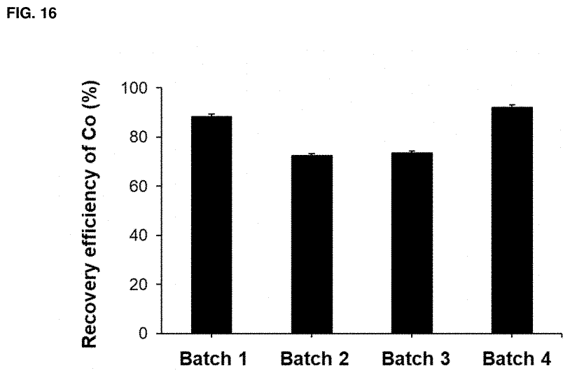

As shown in FIG. 15, on the basis of the atomic weight ratio of Co and O, it strongly revealed that the predominant oxides recovered using the OP approach is Co (II) hydroxide, Co(OH)₂ with traces of Al (6.76%) and Cu (1.42%) impurities. Additionally, recovery efficiency of Co across four independent batches of OP leachate displayed good consistency with an average recovery rate of >73% (FIG. 16).

TABLE 13
Recovery efficiency of cobalt (Co) from 4 different batches
of the orange peel (OP) leaching solution.

| Batch No. of Orange | Recovery efficiency |
|---|---|
| Peel Leaching Solution | of Co (%) |
| Batch 1 | 88 |
| Batch 2 | 72 |
| Batch 3 | 73 |
| Batch 4 | 92 |

### Example 14: Regeneration of New Lithium-Ion Batteries

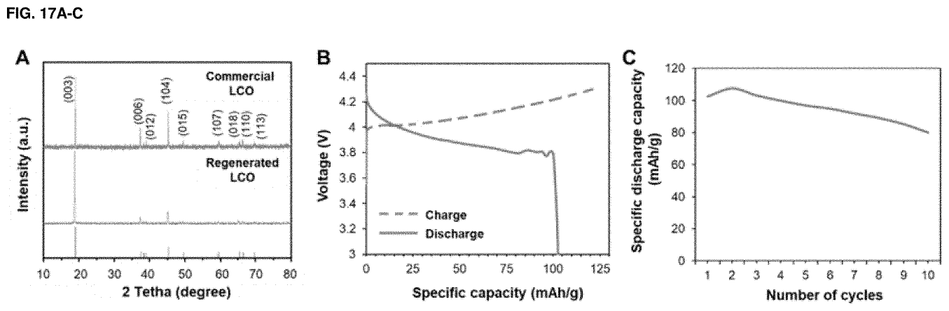

To synthesize LCO, the dried recovered precipitate of cobalt hydroxide was mixed with Li₂CO₃ (atomic ratio of Co/Li=1:1.1). Excess lithium (Li) was added to compensate for the thermal decomposition of Li during the thermal treatment. The mixture was then calcined at 850° C. for 5 hours to form LCO. Successful formation of single-phase LCO (rhombohedral R3m space group crystal system) was validated by examining the crystal structure of the calcined product via X-ray Powder Diffraction (XRD). The XRD diffraction pattern of the calcined materials exhibited a good match with the commercial LCO as shown in FIG. 17A.

Coin cell batteries were assembled using the recycled LCO as the cathode material. Electrode slurry was prepared by mixing the recovered LCO, super P carbon and PVDF binder (weight percent (%) ratio: 80:10:10) in N-methyl-2-pyrrolidone (NMP) solvent. The slurry was coated onto an aluminium current collector and dried in the vacuum oven overnight at 90° C. Lithium-ion coin cell batteries were fabricated in an argon (Ar) filled glove box (MBRAUN) using this cathode and Li metal as the anode and LiPF₆ in ethylene carbonate (EC)/diethyl carbonate (DEC) as the electrolyte.

To assess the cyclic performance of the recycled Li ion coin cell batteries, the batteries were subjected to galvanostatic charge-discharge testing at 0.1 C at a constant rate at room temperature using Neware battery tester. The upper limit of the voltage used in the test was set to be 5 V and the current was set to range from −1 to 1 mA. Voltage and current data were recorded every 30 seconds.

Cyclic performance data revealed that the newly generated LIBs from the black mass samples possessed a comparable initial charge capacity to the commercial LIBs (about 120 mAh/g) and the initial discharge capacity was approximately 103 mAh/g (FIG. 17B). Further analysis revealed the recycled LIBs had a desirable stable performance within 10 cycles of charge and discharge, with less than 20% capacity lost in the 10th cycle (FIG. 17C). This suggests that this new technology is practically feasible for recycling spent LIBs in the industrial sense.

Statistical Analysis

All experiments in this study were carried out with triplicates. Data are presented by mean±standard deviation (SD) with p value indicated where necessary. Origin 9 (OriginLab) was used for statistical analysis. Experimental data were subjected to either Student's t-test or one-way analysis of variance (ANOVA) where applicable. Statistical differences are indicated with probability value (p value) in the associated text or figure caption.

### INDUSTRIAL APPLICABILITY

Due to the heavy dependence on the incineration process to deal with LIBs waste, from which numerous toxins and pollutants are generated and subsequently released to the environment, the present disclosure can potentially be applied globally to treat, reduce, recycle, regenerate and recover LIBs waste into useful batteries, and transform the present processing methodology in a greener manner with minimal pollution and low energy consumption (mild heating).

The disclosed method can be applied industrially in various electronic industries and even waste industries such as electronic waste and food and fruit waste industries. The disclosed method can obtain metal ions from a battery and recover lithium cathode material from lithium-ion batteries. It can in turn make use of fruit waste to extract metal ions from battery waste and recycle and regenerate these metal ions into useful batteries.

Further, the present disclosure provides a significant improvement relative to the currently available hydrometallurgical methods which frequently involve strong acids and hydrogen peroxide, leading to secondary pollution and life threats to the workers who perform duties in the relevant fields. With numerous advantages of the present disclosure over the current strategies, the use of fruit peel waste as a novel reductant for hydrometallurgical extraction of valuable metals from spent battery wastes can potentially be applied to the entire spectrum of the food waste and electronic waste related industries. The disclosed method is environmental-friendly, cost-effective, safe and can recover and regenerate metals for use as batteries in many applications.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of obtaining metal ions from a battery, the method comprising adding a crushed battery to a leaching solution comprising fruit and organic acid, thereby obtaining a leachate comprising metal ions, wherein the method is performed at a temperature above 80° C.

2. The method of claim 1, wherein the method is performed at a temperature in the range of about 90° C. to about 120° C.

3. The method of claim 1, wherein the crushed battery is obtained by shredding, pulverizing, grinding, cutting, and/or blending a battery.

4. The method of claim 1, wherein the fruit is selected from the group consisting of orange, pear, lemon, apple, banana, lime, pineapple, grapefruit, blackberry, raspberry, cranberry, tamarind, grape, mango, papaya, honeydew, pomelo, watermelon, kiwi, plum, peach, lime, sweet potato, avocado, cucumber, dragon fruit, guava, jackfruit, durian, and mixtures thereof,
and wherein the fruit comprises its peel, flesh and/or seeds.

5. The method of claim 4, wherein the fruit is primarily fruit peel.

6. The method of claim 4, wherein the fruit is in powder form.

7. The method of claim 6, wherein the average particle size of the fruit powder is in the range of about 100 μm to about 500 μm.

8. The method of claim 1, wherein the organic acid is selected from the group consisting of citric acid, acetic acid, tartaric acid, maleic acid, oxalic acid, L-ascorbic acid, succinic acid, quinic acid, isocitric acid, tannic acid, caffeic acid, lactic acid, formic acid, uric acid, barbituric acid, benzenesulfonic acid, benzoic acid, bromoacetic acid, chloroacetic acid, fumaric acid, gallic acid, methane sulfonic acid, phthalic acid, propionic acid, salicylic acid, sorbic acid, p-toluene sulfonic acid, fluoroantimonic acid, erucic acid, lauric acid, butyric acid, and mixtures thereof.

9. The method of claim 8, wherein the concentration of organic acid is in the range of about 1.0 M to about 5.0 M.

10. The method of claim 1, wherein the metal ions comprise nickel, manganese, cobalt, lithium, iron, vanadium, silicon, titanium, tin, chromium, copper and/or aluminum ions.

11. The method of claim 1, wherein the density of the crushed battery in the leaching solution (w_{crushed battery}/v_{leaching solution}) is about 5 g/L to about 50 g/L.

12. A method of obtaining metal salt from a battery, the method comprising:
(i) adding a crushed battery to a leaching solution comprising fruit and organic acid, thereby obtaining a leachate comprising metal ions; and
(ii) adding a first precipitating agent to the leachate of step (i), thereby obtaining a first precipitate comprising metal salt and filtrate,
wherein step (i) is performed at a temperature above 80° C.

13. The method of claim 12, further comprising step (iii) adding a second precipitating agent to the filtrate of step (ii) to obtain a second precipitate.

14. The method of claim 12, wherein the first precipitating agent is selected from the group consisting of sodium hydroxide (NaOH), sodium chloride (NaCl), sodium bisulfate (NaHSO₄), monosodium phosphate (NaH₂PO₄), sodium carbonate (Na₂CO₃), sodium bicarbonate (NaHCO₃), trisodium phosphate (Na₃PO₄), sodium sulfite (Na₂SO₃), disodium phosphate (Na₂HPO₄), calcium hydroxide (Ca(OH)₂), magnesium hydroxide (Mg(OH)₂), and any mixture thereof.

15. The method of claim 12, wherein the first precipitate comprises manganese salt and/or nickel salt.

16. The method of claim 13, wherein the second precipitating agent comprises alcohol.

17. The method of claim 13, wherein the second precipitate comprises cobalt salt.

18. A method of recovering and regenerating lithium cathode material from lithium-ion battery (LIB), the method comprising:
(i) adding a crushed LIB to a leaching solution comprising fruit and organic acid, thereby obtaining a leachate comprising metal ions;
(ii) adding a first precipitating agent to the leachate of step (i), thereby obtaining a first precipitate comprising metal salt and filtrate;
(iii) adding a second precipitating agent to the filtrate of step (ii) to obtain a second precipitate; and
(iv) mixing the second precipitate of step (iii) with a lithium salt and heating the resulting mixture to obtain a lithium cathode material;
wherein step (i) is performed at a temperature above 80° C.

19. The method of claim 18, wherein the lithium salt is selected from the group consisting of lithium hydroxide, lithium carbonate, lithium nitrate, lithium acetate, lithium oxalate, lithium chloride, lithium phosphate, lithium sulfate, lithium borate, lithium oxide, and any mixture thereof.

20. The method of claim 18, wherein the lithium cathode material is selected from the group consisting of lithium cobalt oxide (LCO), lithium manganese oxide (LMO), lithium nickel manganese cobalt oxide (LNMCO), lithium titanium oxide (LTO), lithium iron phosphate (LFP), lithium oxido(oxo)nickel (LiNiO₂), lithium manganese dioxide (LiMnO₂), LiNi_{0.5}Mn_{1.5}O₄ (Spinel, LNMO), lithium manganese phosphate (LiMnPO₄), lithium nickel phosphate (LiNiPO₄), lithium cobalt phosphate (LiCoPO₄), and any mixture thereof.
